(19) United States
(12) Patent Application Publication
(10) Pub. No.: US 2026/0006024 A1
(43) Pub. Date: Jan. 1, 2026

(54) INTEGRATED SCHOOL SAFETY SYSTEM

(71) Applicant: Raptor Technologies LLC, Houston, TX (US)

(72) Inventors: Peter J. Trate, Houston, TX (US); David Van Camp, Houston, TX (US); Seth Forst, Houston, TX (US)

(21) Appl. No.: 19/179,806

(22) Filed: Apr. 15, 2025

Related U.S. Application Data
(60) Provisional application No. 63/634,029, filed on Apr. 15, 2024.
(60) Provisional application No. 63/673,520, filed on Jul. 19, 2024.

(51) Int. Cl. H04L 9/40

(52) U.S. Cl. CPC H04L 63/083; H04L 63/102

(57) ABSTRACT

A computer-implemented method includes receiving, from a plurality of computing systems each associated with a respective school of a plurality of schools, information for a plurality of persons, each person of the plurality of persons being associated with one or more schools of the plurality of schools; sending, to an electronic device, an invitation for a first person of the plurality of persons to obtain a first digital credential that is configured to enable the first person to access one or more facilities of each of the plurality of schools; receiving, from the electronic device, identification information for the first person; authenticating the first person using the identification information for the first person; and in response to authenticating the first person, providing, to the electronic device, the first digital credential.

### CROSS-REFERENCE TO RELATED APPLICATIONS

The present application claims priority to U.S. Provisional Patent Application Ser. No. 63/634,029, which was filed on Apr. 15, 2024, and U.S. Provisional Patent Application Ser. No. 63/673,520, which was filed on Jul. 19, 2024, the entirety of which are hereby incorporated by reference into the present application.

### TECHNICAL FIELD

The present disclosure relates to managing and controlling student movement and personnel access to schools.

### BACKGROUND

School systems handle large numbers of students arriving and departing from multiple different schools each day. Additionally, people having various roles associated with schools visit schools during and after school hours. Roles can include parents, visitors, faculty, staff, volunteers, and contractors.

### SUMMARY

The present disclosure describes apparatus, systems, and methods for managing school safety. In some implementations, a system is provided to track student activity and custody in and around schools. In some implementations, the system is configured to track and manage personnel access to schools.

In an example implementation, a computer-implemented method includes receiving, from a plurality of computing systems each associated with a respective school of a plurality of schools, information for a plurality of persons, each person of the plurality of persons being associated with one or more schools of the plurality of schools; sending, to an electronic device, an invitation for a first person of the plurality of persons to obtain a first digital credential that is configured to enable the first person to access facilities of each of the plurality of schools; receiving, from the electronic device, identification information for the first person; authenticating the first person using the identification information for the first person; and in response to authenticating the first person, providing, to the electronic device, the first digital credential.

In an aspect combinable with the example implementation, each person of the plurality of persons is assigned to at least one role of a plurality of roles.

In another aspect combinable with one, some, or all of the previous aspects, the plurality of roles include at least a guardian role and a student role, wherein each person assigned to the guardian role is associated with at least one person assigned to the student role.

In another aspect combinable with one, some, or all of the previous aspects, the plurality of roles include one or more of: a visitor role, a faculty role, a staff role, a volunteer role, a guardian role, and a student role.

In another aspect combinable with one, some, or all of the previous aspects, sending, to the electronic device, the invitation to obtain the first digital credential includes identifying, from the information received from the plurality of computing systems, an electronic contact address for the first person; and sending the invitation to the electronic contact address for the first person.

Another aspect combinable with one, some, or all of the previous aspects includes storing the information for the plurality of persons in a database.

Another aspect combinable with one, some, or all of the previous aspects includes generating the first digital credential in response to determining that the received identification information for the first person satisfies criteria for matching information for the first person stored in the database.

In another aspect combinable with one, some, or all of the previous aspects, the identification information for the first person includes data representing an identification document for the first person, the computer-implemented method including storing, in the database, the data representing the identification document for the first person.

Another aspect combinable with one, some, or all of the previous aspects includes performing a screening for the first person using the data representing the identification document.

In another aspect combinable with one, some, or all of the previous aspects, the identification information for the first person includes data representing an identification document for the first person; and one or more images generated by a camera of the electronic device.

In another aspect combinable with one, some, or all of the previous aspects, authenticating the first person using the identification information includes determining that the data representing the identification document for the first person satisfies criteria for matching the one or more images generated by the camera of the electronic device.

In another aspect combinable with one, some, or all of the previous aspects, the identification information for the first person includes one or more images generated by a camera of the electronic device, and authenticating the first person using the identification information includes performing liveness detection on the one or more images generated by the camera of the electronic device.

In another aspect combinable with one, some, or all of the previous aspects, each person of the plurality of persons is assigned to one or more of a plurality of roles, the plurality of roles including at least a guardian role and a student role, wherein each person assigned to the guardian role is associated with at least one person assigned to the student role, and the computer-implemented method includes determining that the first person is assigned to the guardian role; determining at least one student associated with the first person, wherein a student includes a person who is assigned to the student role; and in response, providing, to the electronic device, access to a student management application, wherein the access to the student management application enables the first person to request changes to stored information for the at least one student.

In another aspect combinable with one, some, or all of the previous aspects, the at least one person assigned to the student role includes a first student and a second student.

In another aspect combinable with one, some, or all of the previous aspects, the first student and the second student attend the same school of the plurality of schools or attend different schools of the plurality of schools.

Another aspect combinable with one, some, or all of the previous aspects includes providing, through the student management application, a user interface that enables the first person to request a change in information for a first student of the at least one person assigned to the student role; receiving, through the student management application, a request for a first change of information for the first student; and in response, performing the first change of information for the first student in a database.

In another aspect combinable with one, some, or all of the previous aspects, the first change of information for the first student includes a change to an after-school dismissal action for the first student, wherein the change includes at least one of: assigning the first student to a bus; assigning the first student to a bus stop; or assigning the first student to a carpool.

In another aspect combinable with one, some, or all of the previous aspects, the change to the after-school dismissal action includes assigning the first student to a carpool assigned to a second person of the plurality of persons, and the computer-implemented method includes: identifying, from the database, an electronic contact address for the second person; and sending, to electronic contact address for the second person, a notification that the first student is assigned to the carpool.

In another aspect combinable with one, some, or all of the previous aspects, each person of the plurality of persons is assigned to at least one role of a plurality of roles; and a digital credential for a person of the plurality of persons indicates the assigned at least one role assigned to the person.

In another aspect combinable with one, some, or all of the previous aspects, each role of the plurality of roles is associated with corresponding access criteria and is permitted to access the facilities of the plurality of schools when the corresponding access criteria is satisfied; and the method further includes detecting, at an access point to a facility of a school of the plurality of schools, a digital credential; identifying one or more assigned roles indicated by the digital credential; and determining, based on the one or more assigned roles, whether the corresponding access criteria is satisfied for entry through the access point to the facility.

Another aspect combinable with one, some, or all of the previous aspects includes, in response to determining that the corresponding access criteria is satisfied, allowing the person to proceed through the access point.

In another aspect combinable with one, some, or all of the previous aspects, allowing the person to proceed through the access point includes unlocking a door of the school.

Another aspect combinable with one, some, or all of the previous aspects includes, in response to allowing the person to proceed through the access point, updating a database to indicate that the person has accessed the school.

Another aspect combinable with one, some, or all of the previous aspects includes, in response to determining that the corresponding access criteria is not satisfied, preventing the person from proceeding through the access point.

In another aspect combinable with one, some, or all of the previous aspects, preventing the person from proceeding through the access point includes at least one of locking a door of the school; maintaining the door of the school locked; alerting a staff member to confirm the person's identity; or activating an alarm.

In another aspect combinable with one, some, or all of the previous aspects, the access criteria includes at least one of permissions to enter through a designated access point of multiple access points of the school; or permissions to enter the school within a designated time range.

In another aspect combinable with one, some, or all of the previous aspects, two or more of the plurality of schools are associated with a single school system having a common administration.

In another aspect combinable with one, some, or all of the previous aspects, two or more the plurality of schools are associated with multiple different school systems having different respective administrations.

In another aspect combinable with one, some, or all of the previous aspects, providing, to the electronic device, the first digital credential includes storing, on the electronic device, a scannable code for authenticating the first person.

In another aspect combinable with one, some, or all of the previous aspects, the scannable code is a barcode or a quick response (QR) code.

In another aspect combinable with one, some, or all of the previous aspects, the scannable code is configured to be presented on the electronic device for processing by a second electronic device for verification of the first person's identity.

Another aspect combinable with one, some, or all of the previous aspects further includes receiving, from the electronic device, registration information, the registration information including a request to register the first person for an event; and in response to receiving the registration information, providing, to the electronic device, a second digital credential, the second digital credential being specific to the event.

In another aspect combinable with one, some, or all of the previous aspects, providing, to the electronic device, the second digital credential includes storing, on the electronic device, a scannable code for authenticating the first person at the event.

In another aspect combinable with one, some, or all of the previous aspects, the scannable code is a barcode or a quick response (QR) code.

In another aspect combinable with one, some, or all of the previous aspects, the scannable code is configured to be presented on the electronic device for processing by a second electronic device for verification of the registration of the first person for the event.

Other implementations of any of the above aspects include corresponding systems, apparatus, and computer programs that are configured to perform the actions of the methods, encoded on computer storage devices. The present disclosure also provides a tangible, non-transitory computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that aspects and features in accordance with the present disclosure can include any combination of the aspects and features described herein. That is, aspects and features in accordance with the present disclosure are not limited to the combinations of aspects and features specifically described herein, but also include any combination of the aspects and features provided.

Among other advantages, implementations of the systems and methods may include one, some, or all of the following features. For example, systems and methods described herein can provide strengthen safety initiatives and automate crucial safety workflows for schools. The supporting mobile applications described herein can provide simplified, consolidated, and fast access to security services for students, guardians, communities, and staff. The systems described herein can enable schools to execute a comprehensive range of school safety objectives including preventive measures, emergency preparation, response, and recovery, and proactive initiatives to reduce risk. The systems and methods described herein can create safer environments with greater efficiency across schools throughout multiple school districts.

The systems and methods described herein can enable real-time engagement with parents, guardians and community members through simplified school visit approvals, student dismissal options, and event ticketing and payments. Parents can schedule a student's absence, check-in, or check-out at large campus events with a simple tap on their phone.

The systems and methods described herein can provide schools with the ability to manage high volumes of visitors efficiently and safely, while providing extensive flexibility through safety profiles as well as automated registration and ticketing for public events. The systems and methods described herein can enable schools and related administrations to manage numerous workflows for students, staff, contractors, volunteers, and visitors in combination across school campuses. Techniques include providing a long term or permanent digital credential, or “passport,” for frequent school visitors, or a temporary access code for one-time visitors. High levels of security are maintained in order to ensure safe individuals are in school buildings. Should an emergency occur on campus during a sporting event or other activity, school administrators and first responders can easily account for and reunify those in attendance using the systems and methods described herein.

The systems and methods described herein accounts for student movement and safety throughout the day. The systems and methods described herein coordinate and simplify student dismissal to buses, cars, and after-school activities while verifying the students are leaving with safe, approved individuals.

The system and methods described herein can enable guardians to update a status for a student. For example, the system and methods described herein can enable guardians to modify their student's dismissal mode for a single day or on a schedule. The system and methods described herein can also enable guardians to provide attendance information for a student. In addition, the systems and methods described herein can enable guardians to review a student's attendance record.

The systems and methods described herein can enable users to access volunteer opportunities. For example, the systems and methods described herein can enable community members to apply to a volunteer program and can enable approved volunteers to manage their profile, view volunteer events/activities, re-apply to continue approval volunteer status, and/or communicate with other volunteers or administrators.

In some implementations, the systems and methods described herein can enable users to receive emergency alerts regarding matters at a school.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

FIG. 1 depicts an example environment in which implementations of the present disclosure may be employed.

FIG. 2 depicts an example process for a computing device executing obtaining a digital credential and executing a student change in accordance with implementations of the present disclosure.

FIG. 3 is a flow chart of an example process for accessing a student management application in accordance with implementations of the present disclosure.

FIGS. 4A, 4B, 5A, 5B, 5C, 5D, 5E, 5F, and 5G depict an example computing device obtaining a digital credential in accordance with implementations of the present disclosure.

FIG. 6 depicts an example computing device presenting a user interface for selecting roles in accordance with implementations of the present disclosure.

FIGS. 7-10 depict an example computing device executing a request for a student release change in accordance with implementations of the present disclosure.

FIGS. 11-17 depict an example computing device executing an example change to a student carpool schedule in accordance with implementations of the present disclosure.

FIGS. 18-23 depict an example computing device executing an example change to a student bus schedule in accordance with implementation of the present disclosure.

FIGS. 24-27 depict an example computing device executing a change to a student after school activity schedule in accordance with implementations of the present disclosure.

FIGS. 28-31 depict an example computing device executing an example change to authorized guardians for a student in accordance with implementations of the present disclosure.

FIGS. 32-36 depict example user interfaces for scheduling and managing events associated with one or more schools.

FIG. 37 depicts an example computing device executing a request for an access credential for an event.

FIG. 38 depicts another example computing device executing a request for an access credential for an event.

FIG. 39 depicts an example computing device executing a request to display a list of events that a user has registered to attend.

FIG. 40 depicts an example computing device displaying a temporary access credential for the user for an event the user has registered to attend.

FIG. 41 depicts an example computing system architecture in accordance with implementations of the present disclosure.

### DETAILED DESCRIPTION

The present disclosure describes apparatus, systems, and methods for monitoring student safety. In some implementations, an application is provided to track student location, activity, and custody.

Example features of the integrated student safety and tracking system described herein include an integrated visitor management system that expands the visitor experience by adding self-service options, support for new platforms, a digital passport for frequent visitors, and incorporating large scale events. An integrated event management system provides security for large-scale events, ticketing, and payments for both on-campus and off-campus activities. A mobile application enables real-time engagement with parents, guardians and community members through simplified school visit approvals, student dismissal options, and event ticketing and payments.

A mobile application enables teachers and staff to manage dismissals, issue digital hall passes, manage student attendance and log low-level concerns about student behavior. The disclosed systems provide student dismissal capabilities designed to coordinate and simplify student dismissal to buses, cars, and after-school activities while verifying that students are leaving with safe, approved individuals.

A digital hall pass management system enhances visibility and accountability for students outside the classroom. An attendance management system includes per-period attendance software that gives teachers more instructional time and reduces administrative burden.

As used herein, a screen may describe a user interface or a portion of a user interface, such as one or more windows, frames, or other collection of presented elements.

As used herein, a gesture may describe any input made by a user to a user interface or to a portion of a user interface. A gesture may include inputs made to a touch-sensing display or other component of a device using a finger or other body part. A gesture may include a tap, tap-and-hold, swipe, pinch, or any combination of these or other inputs. A gesture may also include inputs made using an input actuator such as a pen or rod. A gesture may also include inputs made to a user interface using an input device including, but not limited to, a mouse, a keyboard, a joystick, a touchpad, and so forth. Gestures may also include audio inputs such as voice commands, or haptic inputs such as a shaking or other movement of all or part of a computing device.

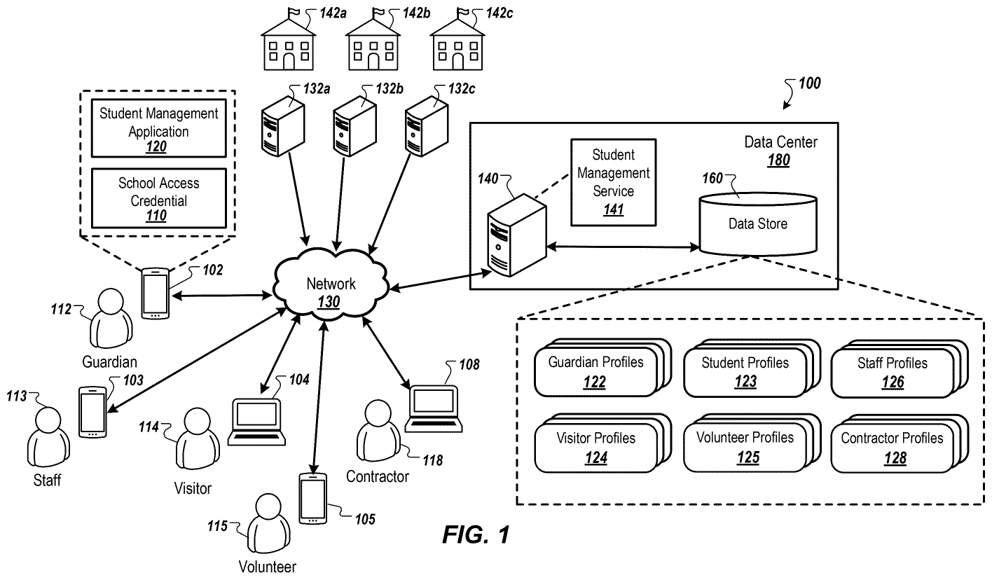

FIG. 1 depicts an example system 100 of multiple computing devices in accordance with implementations of the present disclosure. As shown in the example of FIG. 1, the system 100 can include several computing devices 102, 103, 104, 105, 108 each corresponding to a respective user 112, 113, 114, 115, 118 of the system 100. The system 100 can include computer systems 132a, 132b, 132c (“computer systems 132”), each corresponding to a respective school 142a, 142b, 142c (“schools 142”).

Each user 112, 113, 114, 115, 118 can be associated with a single school or multiple schools 142. The multiple schools 142 can be part of a same school system or can be part of different school systems. A school system can be, for example, a school district that includes a group of schools having a common administration. A school system can include schools covering a range of grade levels. For example, a school system can include any combination of preschools, elementary schools, primary schools, middle schools, junior high schools, high schools, secondary schools, etc.

Each user 112, 113, 114, 115, 118 can be assigned one or more roles in relation to the one or more schools associated with the respective user 112, 113, 114, 115, 118. Roles can include, for example, guardians, visitors, and contractors. In some implementations, roles can include students, faculty, staff, administrative staff, support staff, volunteers, student family, and other roles. In some examples, a user is assigned to two or more roles. For example, a guardian of a student may also be a contractor.

The user 112 is a guardian user (e.g., a user assigned to a role of a guardian). The guardian user 112 is a person who has some responsibility for at least one student in one or more of the schools 142. The guardian user 112 can be, for example, a parent, another other adult family member, or another caretaker for a student. Multiple students can have a same guardian. In addition, a single student can have multiple guardians. The guardian user 112 can be associated with multiple students at the same school, at different schools within a school system, or at different schools within different school systems. The guardian user 112 can be authorized to perform various function such as picking up the associated student(s) from school and updating student records for the associated student(s). The guardian user 112 communicates with the server device 140 using the computing device 102.

The user 114 is a visitor user (e.g., a user assigned to a role of a visitor). The visitor user 114 is a member of the community that visits one or more of the schools 142. For example, the visitor user 114 can visit a school in order to perform volunteer work or to attend an event such as a sporting event or performance.

The user 118 is a contractor user. The contractor user 118 can be, for example, a maintenance worker, information technology worker, cleaning worker, or another worker contracted to work at one or more of the schools 142.

In some examples, users can include a student user (e.g., a user assigned to a role of a student). A student user attends one or more of the schools 142. The student user can be associated with one or more guardians, such as the guardian user 112.

In some examples, users can include a faculty user (e.g., a user assigned to a role of faculty). A faculty user is a school faculty member such as a principal, teacher, or professor. The faculty user can be associated with one or more of the schools 142.

In some examples, users can include a staff user (e.g., a user assigned to a role of a staff). A staff user can be a school staff member such as a coach, administrative worker, maintenance worker, or another non-faculty worker. The staff user can be associated with one or more of the schools 142.

The various computing devices 102, 104, 108, and the computer systems 132 can communicate via one or more networks 130. The network(s) 130 can include public networks such as the internet, private networks such as an institutional or personal intranet, or any combination of private and public networks. The network(s) 130 can include any type of wired or wireless network, including but not limited to local area networks (LANs), wide area networks (WANs), wireless WANs (WWANs), or wireless LANs (WLANs). The network(s) 130 can also include mobile communications networks including, but not limited to, a 3G network, a 4G network, an Edge network, a Long Term Evolution (LTE) network, and so forth. In some implementations, the communications between computing devices 102, 103, 104, 105, 108 over the network(s) 130 can be encrypted or otherwise secured. For example, communications can employ one or more public or private cryptographic keys, ciphers, digital certificates, or other credentials supported by a security protocol, such as any version of the Secure Sockets Layer (SSL) or the Transport Layer Security (TLS) protocol.

The computing devices 102, 104, 108, and the computer systems 132 can employ the network(s) 130 to communicate with a data center 180 that includes one or more server devices 140 and a data store 160. In some cases, the data center 180 can be remote or off-site with respect to the schools. The server device(s) 140 can include any number and any type of computing devices, such as server computers, network computers, mainframe computers, distributed computing devices (e.g., cloud servers), and so forth. The server device(s) 140 can execute any number of software modules (not shown), such as processes, applications, libraries, interfaces, and so forth, to provide a student management service 141.

The data store 160 can include any number and any type of data storage devices, storage nodes, databases, and so forth. The data store 160 can be component(s) of the server device(s) 140, or can be external to the server device(s) 140. The data store 160 can employ any type of data storage format, and can include relational databases or non-relational data stores. In some cases, at least a portion of the data stored in the data store 160 can be received from other management services, such as a visitor management service that tracks the identify, location, status, or other information regarding visitors (e.g., guardians, vendors, contractors, emergency responders, media, volunteers, etc.) currently present at a school.

The data store 160 stores data including, but not limited to, profile information related to the various users 112, 113, 114, 115, 118. In some examples, the data store 160 stores profiles for users who are assigned to various roles. For example, the profile information can include guardian profiles 122, student profiles 123, visitor profiles 124, volunteer profiles 125, staff profiles 126, and contractor profiles 128. In some examples, the profile information includes faculty profiles, staff profiles, or both.

The data store 160 can store data received from the computing devices 102, 104, 108, the computer systems 132a, 132b, 132c, or any combination thereof.

In some examples, each school 142a, 142b, 142c obtains information about one or more persons associated with the school. For example, the school 142a can obtain information related to students enrolled at the school 142a and to guardians 112 of the students. The school 142a can also obtain information related to visitors 114 who have visited and/or will visit the school 142a. The school 142a can also obtain information related to contractors 118 who have worked at and/or will work at the school 142a. The information obtained by each of the schools 142 can be received at and/or stored by the respective computer systems 132 of the school 142. For example, information obtained by the school 142a can be received by the computer system 132a, stored by the computer system 132a, or both.

The computer systems 132 can communicate with the server device 140 over the network 130. For example, the computer system 132a can send information related to students, guardians, contractors, volunteers, staff, and visitors of the school 142a to the server device 140 over the network 130. In some examples, the computer system 132a sends the information to the server device 140 periodically (e.g., weekly, monthly, semesterly) or when a change occurs (e.g., information for a newly enrolled student is received by the computer system 132). In some examples, the computer system 132a sends the information to the server device 140 on demand (e.g., when a user of the computer system 132a submits a request for the information to be sent to the server 140).

The server device 140 receives information from each of the computer systems 132a, 132b, 132c. The server device 140 can store the received information in the data store 160. Thus, the data store 160 stores data related to guardians 112, visitors 114, contractors 118, staff 113, and volunteers 115 of each of the schools 142a, 142b, 142c.

Guardian profiles 122 include information related to guardians of students that attend the schools 142. A guardian profile 122 for a guardian can include one or more of the following: a guardian's name, address, contact information, image of the guardian, information about student(s) associated with the guardian, a list of schools and/or facilities that the guardian is permitted to access, a link to associated students' profiles, and other information.

The guardian profile 122 can include information related to a carpool for which the guardian is responsible. The carpool information can include vehicle information such as a make, model, color, and/or license plate of the vehicle(s) that the guardian operates. The carpool information can include a list of students who are assigned to the carpool.

In some examples, the carpool information includes schedule data representing a schedule of assigned students for the carpool. For example, the schedule data can indicate that on Mondays through Thursdays, Student A and Student B are dismissed to Carpool H for which the guardian is responsible, and that on Fridays, only Student A is dismissed to Carpool H.

Student profiles 123 include information related to students that attends one of the schools 142. A student profile 123 for a student can include one or more of the following: the student's identification number, the student's name, a description of the student's appearance, an image of the student, the student's age, the student's grade, the student's school, the student's address, the student's teacher, a list of schools and/or facilities that the student is permitted to access, identifying information for authorized guardian(s) of the student, a link to associated guardians' profiles, and other information.

The student profile 123 can include information related to arrival and/or dismissal options for the student. For example, the student profile 123 can include information indicating a carpool and/or a bus that the student is assigned to before or after school.

In some examples, the student profile 123 include schedule data representing a schedule of arrival and dismissal assignments for the student. For example, the schedule data for before school can indicate that a particular student attends before-school care on Mondays and Fridays, and takes Bus G to school at normal school start time on Tuesdays, Wednesdays, and Thursdays. The schedule data for after school can indicate that the particular student carpools in Carpool A on Mondays and Fridays, attends after-school care on Wednesdays, and takes Bus G to Bus Stop 12 on Tuesdays and Thursdays. In some examples, the schedule data represents a repeated schedule from week-to-week. In some examples, the schedule data represents a schedule that changes over time.

In some examples, the student profile 123 includes information that may be updated upon the student's arrival to and/or departure from school. For example, the student profile 123 can include the current status of the student (e.g., checked in to before-school care, arrived at school on Bus G, dismissed to the guardian responsible for Carpool A, boarded Bus G after school, checked in to after-school care, etc.).

In some examples, the student profile 123 includes information that may be updated during an emergency response situation, such as the current status of the student (e.g., injured, healthy, reunified, not reunified, missing, accounted for) and the current location of the student.

Visitor profiles 124 include information related to visitors of the schools 142. A visitor profile 124 for a visitor can include one or more of the following: a visitor's name, address, contact information, image of the visitor, event(s) that the visitor has attended or will attend at a school, a record of the methods by which the visitor's identity was verified (or not) at schools and events at which the user visited and any associated metadata, a list of schools and/or facilities that the visitor is permitted to access, and other information.

Volunteer profiles 125 include information related to volunteers of the schools 142. A volunteer profile 125 for a volunteer user can include one or more of the following: the volunteer's name, address, contact information, image of the volunteer, event(s) at which the visitor has volunteered or will volunteer at a school, a record of the methods by which the volunteer's identity was verified (or not) at schools and events at which the user volunteered and any associated metadata, a list of schools and/or facilities at which the user is permitted to volunteer, and other information.

Staff profiles 126 include information related to staff of the schools 142 or associated administrations (e.g., school districts). A staff profile 126 for a staff user can include one or more of the following: the staff user's name, address, contact information, image of the staff user, the school employing the staff user and/or or the school district or system employing the staff user.

Contractor profiles 128 include information related to contractors who are employed by one or more of the schools 142. A contractor profile 128 can include one or more of the following: a government identification number (e.g., driver's license number, social security number), a name, a description of the contractor's appearance, an age of the contractor, an image of the contractor, the job position or role of the contractor, an address, contact information, a list of schools and/or facilities that the contractor is permitted to access, and other information. The contractor profile 128 can also include information that can be updated during an emergency response situation, such as the current location of the contractor (e.g., classroom, front office, cafeteria, etc.).

The various computing devices 102, 103, 104, 105, 108 can communicate, over the network(s) 130, with the student management service 141 running on the server device(s) 140. The computing devices 102, 103, 104, 105, 108 can provide data to be employed by the server device(s) 140 to update the data in the data store 160. The computing devices 102, 103, 104, 105, 108 can also receive, process, and present data that the server device(s) 140 have retrieved from the data store 160.

The computing device 102 operates a student management application 120. The guardian 112 can submit information to, and receive information from, the server device 140 through the student management application 120. The computing device 102 stores a school access credential 110, which is a digital credential configured to permit the user 112 to access facilities of the schools 142.

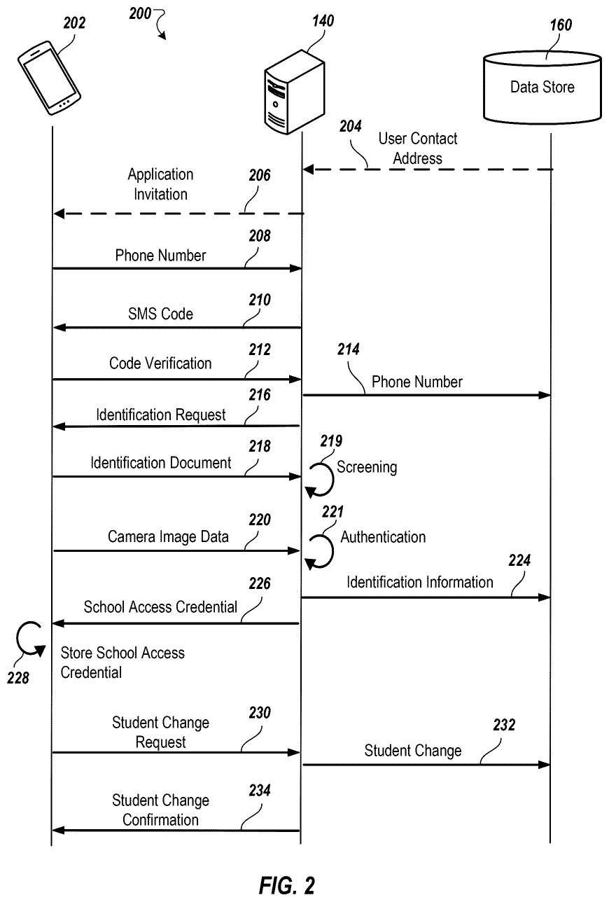

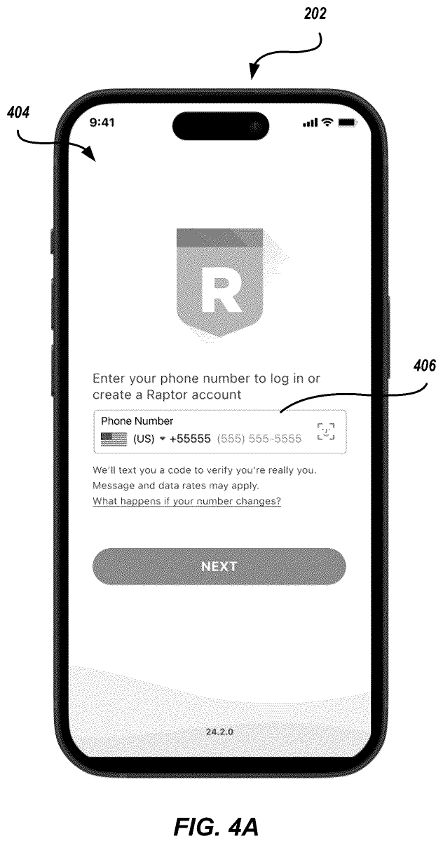

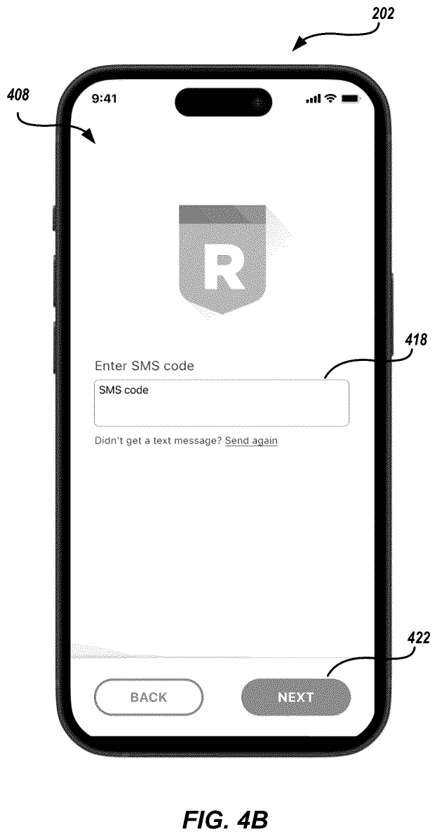

FIG. 2 depicts an example process 200 for an example computing device 202 obtaining the school access credential 110 and executing a student change through the student management application 120. Example user interfaces provided through the computing device 202 are shown in FIGS. 4 to 33. Steps of the process 200 can occur in the illustrated sequence, or in a sequence that is different from the illustrated sequence. For example, steps can occur concurrently or in a different order than shown in FIG. 2.

The computing device 202 can be any of the computing devices 102, 103, 104, 105, 108 of FIG. 1. The computing device 202 can be associated with a user having any of the above-described roles in relation to one or more of the schools 142.

In some implementations, the process of obtaining a school access credential 110 for a new user is initiated in response to a person submitting a request for school access credentials 110 directly to the server device 140, for example using a mobile application on the computing device 202.

In some implementations, the process of obtaining a school access credential 110 for a new user is initiated in response to receiving a person's contact information from a school and sending an application invitation to invite the person to register for a school access credential 110. For example, at step 204, the server device 140 obtains a contact address for a user from the data store 160. In some implementations, the data store 160 receives a list of contact addresses for one or more persons from a school 142, and the data store 160 can store the contact addresses for each of the one or more persons in corresponding user profiles generated for the one or more persons. The contact address can be, for example, a telephone number or email address for a user. In some examples, the server device 140 retrieves contact addresses for users having profiles in the data store 160 who do not have a digital credential and/or access to the student management application 120.

At step 206, in response to receiving the contact information the server device 140 sends an application invitation to a computing device 202 associated with the user. The application invitation can include, for example, an invitation for the user to create an account with the student management service 141, an invitation for the user to obtain a school access credential, or both. The invitation provided sent to the user can be determined based on information received from the data store 160. For example, the information provided by the data store 160 in step 204 can indicate the one or more roles of the user in relationship to the respective school. For example, a contractor user 118 can receive an invitation to obtain the school access credential, and will not receive an invitation to create an account with the student management service 141 if the contractor user 118 is not identified as a guardian for a student at the respective school. However, in an example where the contractor user 118 is also a guardian, the contractor user 118 can receive an invitation to obtain the school access credential and to create an account with the student management service 141.

In some examples, the server device 140 identifies users in the data store who do not have an account with the student management service 141 and sends an invitation to create an account for the role(s) to which the user is assigned. For example, the server device 140 can receive information from a computer system (e.g., computer system 132b) that includes a list of contractors who are assigned to work at the school 142b. Some of the contractors on the list may already have an account with the student management service 141 due to previous work at the school 142b or at a different school 142. The server device 140 can compare the list of contractors to the data store 160 to identify contractors who do not already have an account with the student management service 141 and can send an invitation to the identified contractors.

The server device 140 can be sent by electronic communication such as SMS or email. For a guardian, the invitation can be linked to at least one student profile, and the invitation invites the guardian to create an account for managing information for the linked student profile.

At step 208, in response to receiving the invitation or submitting a request for access to the server device 140, the computing device 202 sends a telephone number to the server device 140. For example, referring to FIG. 4A, in response to receiving the invitation, an example computing device 202 executes an application 120 in accordance with implementations of the present disclosure. In the example of FIG. 4A, in response to receiving the invitation, a user (e.g., user 112) has launched the application 120 on the computing device 202 and a user interface 404 of the application 120 is presented on the computing device 202. The user interface 404 includes a field 406 for entering a telephone number associated with the user. Upon entry of the telephone number, the computing device 202 sends the telephone number to the server device 140.

At step 210, in response to receiving the telephone number from the computing device 202, the server device 140 sends an SMS (short message service) message with a validation code to the computing device 202. In some implementations, the SMS is a sent to the submitted telephone number as a text message with a validation code that can be used to confirm that the telephone number is valid and accessible to the user.

At step 212, in response to receiving the SMS message from the server device 140, the computing device 202 sends a code verification to the server device 140. For example, referring to FIG. 4B, the SMS message can include a validation code and the application 120 presents a user interface 408 including a field 418 for inputting the validation code included in the SMS. When the user inputs the SMS code and selects the “Next” button 422, the computing device 202 sends the validation code to the server device 140 for verification.

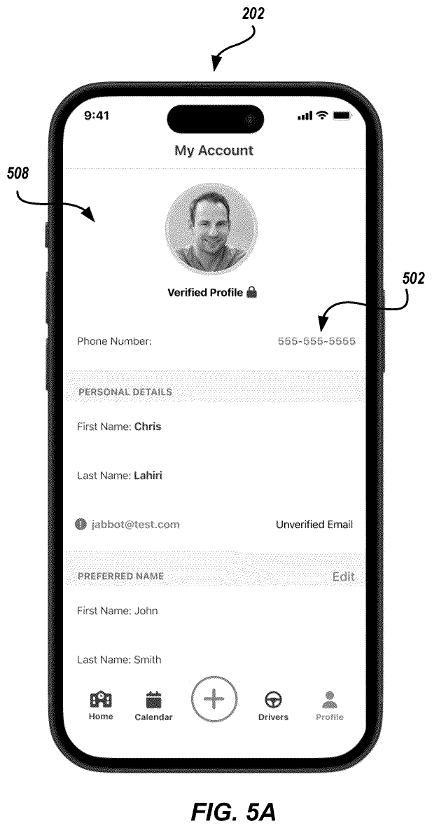

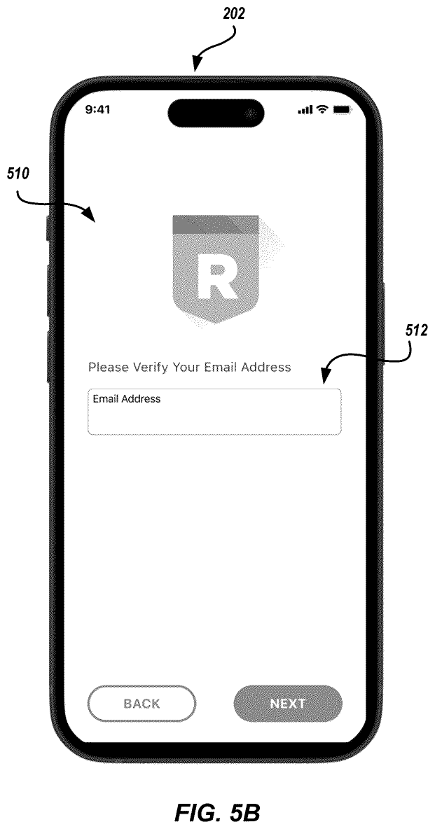

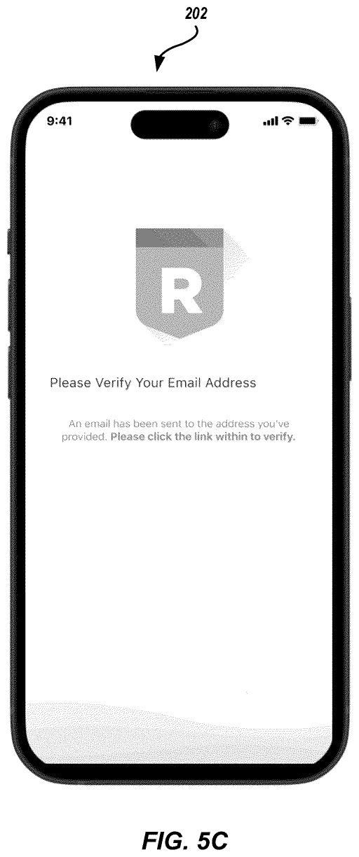

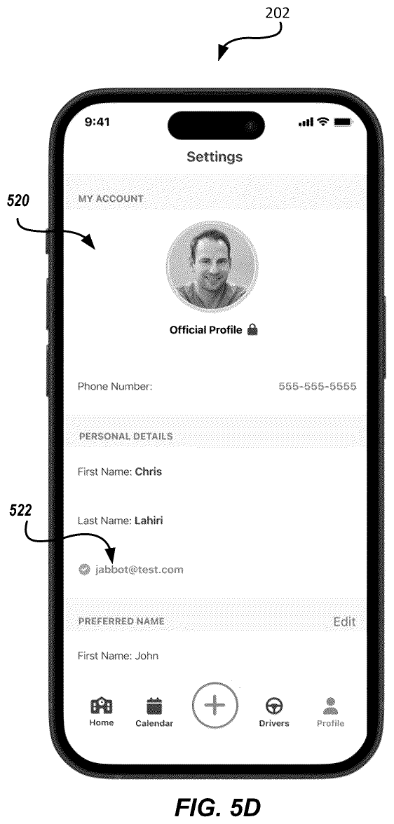

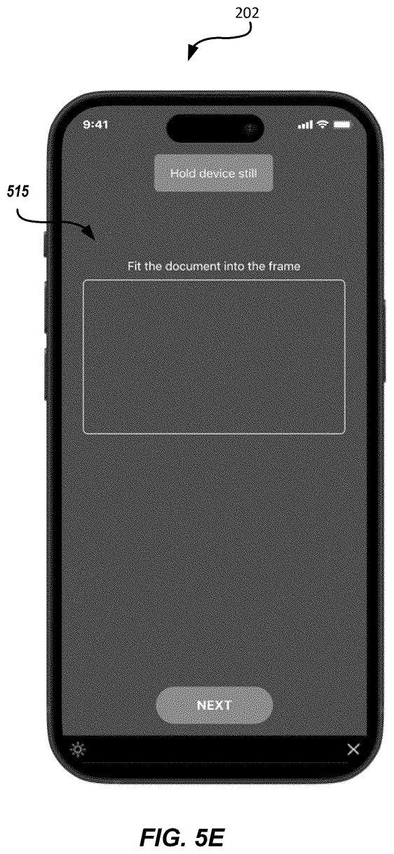

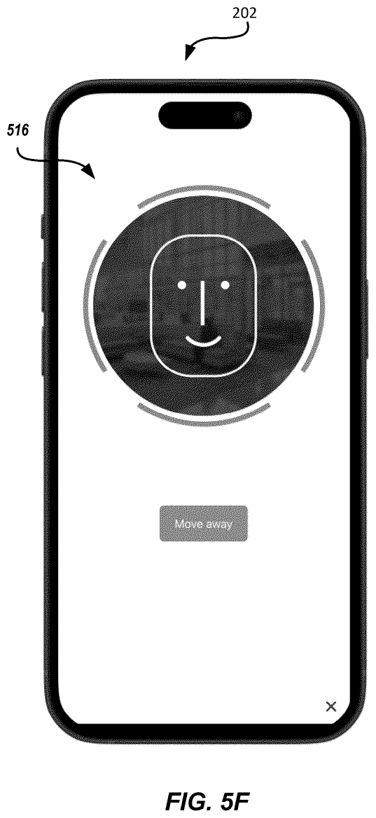

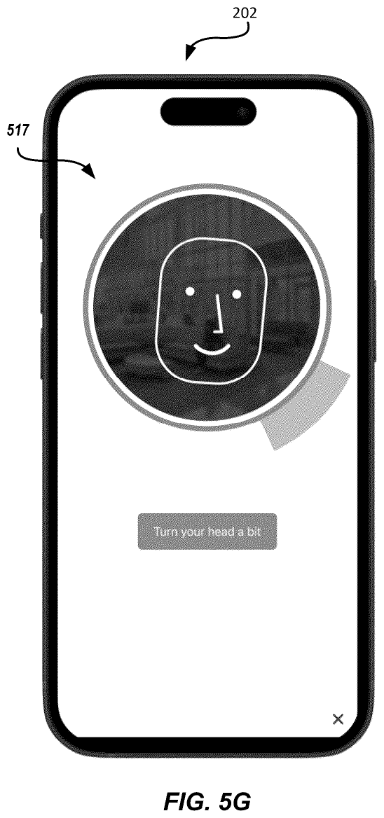

At step 214, the server device 140 stores the telephone number in the data store 160. For example, referring to FIG. 5A, the user's telephone number 502 is added to the user's profile in the data store 160. The stored telephone number 502 then appears in the user interface 508 when the user views their profile on the computing device 202.

In some examples, the steps 208, 210, 212, 214 can be repeated for additional contact information provided for the user. For example, at step 208, the user can add another telephone number or an email address to their profile. The server device 140 can then verify the additional telephone number or email address by sending another validation code to the additional telephone number or email address, which the user then inputs through the user interface, or by sending a link code to the additional telephone number or email address, which the user can select to verify the additional telephone number or email address. For example, referring to FIG. 5B, a user interface 510 includes a field 512 that enables the user to input an email address. Referring to FIG. 5C, after the user inputs the email address, the server device 140 sends a verification link to the email address provided by the user, which the user can access to verify the email address.

At step 216, in response to verifying the user's contact information at step 212, the server device 140 sends an identification request to the computing device 202. The identification request is a request for provision of identifying information for the user. The request can include a request for one or more of the following: an image of an identification document associated with the user (e.g., driver's license, social security card, passport, employee identification card, student identification card), an identification number (e.g., driver's license number, social security number, employee identification number) associated with the user, an image of the user, an occupation of the user, and other types of identifying information.

At step 218, the computing device 202 sends data representing an identification document to the server device 140. For example, the computing device 202 can send an image of the identification document to the server device 140. The user can upload the image of the identification document to the server device 140 through a user interface presented on the computing device 202. Referring to FIG. 5E, in some implementations, the computing device 202 presents a user interface 515 prompting the user to capture image data of the identification document using the camera of the computing device 202.

At step 219, the server device 140 performs a screening. The screening can be a background check or other type of screening. The screening can include, for example, a criminal background check, a motor vehicle records check, an industry ban check, a fraud screening, or any combination thereof.

At step 220, the computing device 202 sends camera image data to the server device 140. The camera image data includes one or more images captured by a camera that is integrated with the computing device 202. The camera image data can include an image or series of images (e.g., a video) of the user. In some examples, the camera image data depicts the user's face.

At step 221, the server device 140 performs authentication 221. In some examples, authentication includes comparing the camera image data to a photograph in the identification document to determine whether the camera image data satisfies criteria for matching the photograph in the identification document. In response to determining that the camera image data satisfies the criteria for matching the photograph identification document, the server device 140 can determine that the person depicted in the camera image data is the same person in the photograph in the identification document.

In some examples, authentication includes performing liveness detection to verify that the camera image data provided in step 220 depicts a live person. Liveness detection can include passive detection, active detection, or a combination of both.

Passive liveness detection occurs without the need for user input. For example, the server device 140 can perform liveness detection by scanning the camera image data for the user's face as well as natural movements such as blinking to verify authenticity. In some examples, the server device 140 can use a three-dimensional liveness check to map a user's face and combat two-dimensional spoofing attempts. Three-dimensional facial recognition can use depth perception to collect more information about facial expressions and subtle changes, making the liveness detection more difficult to defraud.

Active liveness detection involves some form of user input, such as placing a thumbprint on a scanner or following on-screen directions like tilting the head or looking from side to side. Active liveness detection can include a challenge and response check. A challenge and response check asks the user to respond to prompts to perform actions such as blinking, moving the head, smiling, and other actions. The purpose of a challenge and response check is to defeat non-living representations of a person such as two-dimensional photographs or video replay. In some examples, an active liveness check includes requesting multiple biometric inputs, such as any combination of facial, retinal, vocal, and thumbprint scans. For example, referring to FIGS. 5F and 5G, one or more user interfaces 516, 517 can be presented by the computing device 202 that each instruct the user to alter the user's position relative to the camera of the computing device 202 (e.g., instructions to move away from the camera and/or instructions for the user to tilt the user's head). Once the instruction has been performed, the user can capture image data of the user performing the instructions using the camera of the computing device 202 and this image data can be used to confirm liveness.

At step 224, the server device 140 stores identification information in the data store 160. The identification information can include any of the following: data representing the identification document, the camera image data, results of the screening, results of authentication, and other types of information provided to the server device 140 (e.g., from the data store 160 and/or the computing systems 132).

At step 226, in response to completing the screening 219 and the authentication 221, the server device 140 provides a school access credential (e.g., school access credential 110 of FIG. 1) to the user that is associated with the computing device 202. The school access credential can be a digital credential that enables the user to access school facilities within the schools 142. In some examples, the digital credential includes a scannable code such as a barcode or quick response (QR) code that can be presented upon arrival at one of the schools 142 in order to verify the user's access to the school.

In some examples, the school access credential indicates the assigned roles of the user to which the school access credential belongs. For example, the school access credential 110 belonging to the guardian user 112 can indicate that the guardian user 112 is assigned to the role of guardian for one or more students.

In some examples, each role is associated with corresponding access criteria. For example, users associated with a particular role can be permitted to access facilities of the schools 142 according to the corresponding access criteria for the particular role. The access criteria can include, for example, entry through a designated access point of the school, and entry to the school during a designated time range.

For example, users assigned to a guardian role can be permitted to access school facilities during designated time ranges before school and after school, and can be prohibited from access to school facilities during school hours. Users assigned to a contractor role can be permitted to access school facilities during designated time ranges from early morning to late evening on school days.

In some examples, the digital credential is a long-term or permanent credential. For example, a faculty or staff member can obtain a digital credential without an expiration date. In another example, a student can obtain a digital credential that expires on or after the student's expected graduation date. Similarly, a guardian can obtain a digital credential that expires on or after the associated students' expected graduation date.

The digital credential can enable access to any number of the schools 142. The specific schools for which the digital credential provides the respective user access can depend on the role of the user to which the digital credential belongs. For example, a digital credential for a guardian of two students who attend two different schools (e.g., school 142a, 142b,) can enable access to both of the schools 142a, 142b. In some implementations, the digital credential enables access to all schools associated with a particular school district or school system. In some implementations, the digital credential enables access to schools across multiple school districts or school systems. In some examples, a digital credential enables access to all of the schools 142 for which access is managed by the system 100.

In some examples, the digital credential is a temporary credential. For example, a visitor can register for a one-time event at a school. The server device 140 can provide the computing device 202 with a temporary digital credential that enables access to the school during the one-time event and that expires after the event is completed.

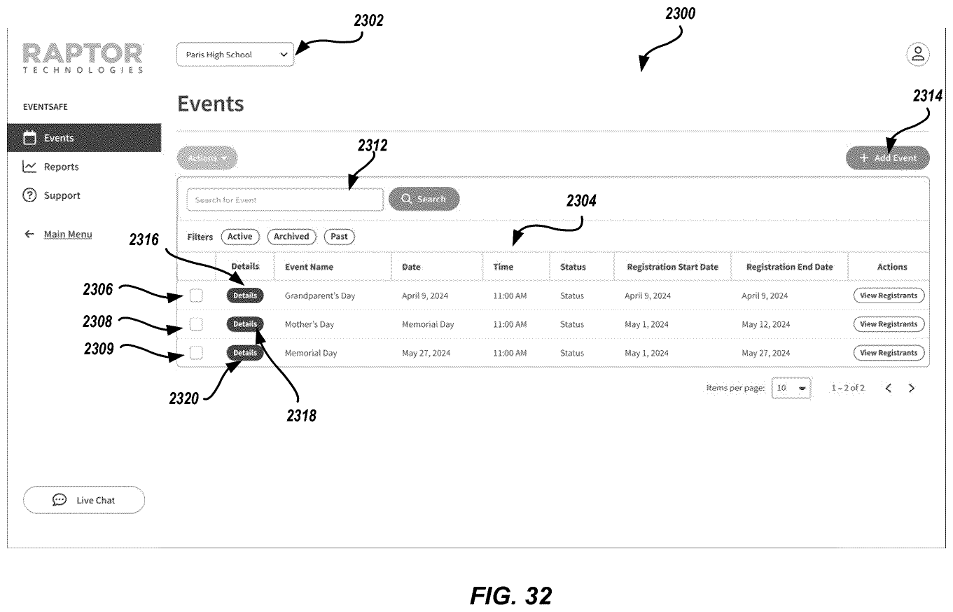

For example, referring to FIG. 32, a user (e.g., staff user 113) can access a user interface 2300 (e.g., using computing device 103) that enables the user to schedule and manage events associated with one or more school. The user interface 2300 includes a selectable element 2302 (e.g., drop down list) for selecting a particular school. In response to selecting a particular school using element 2302, the user interface 2300 displays a list 2304 of scheduled events 2306, 2308, 2309 associated with the selected school. The user interface 2300 also includes a search bar element 2312 that can be used to search for an event associated with the school. The user interface 2300 also includes a selectable element 2314 that can be selected to schedule a new event for the school.

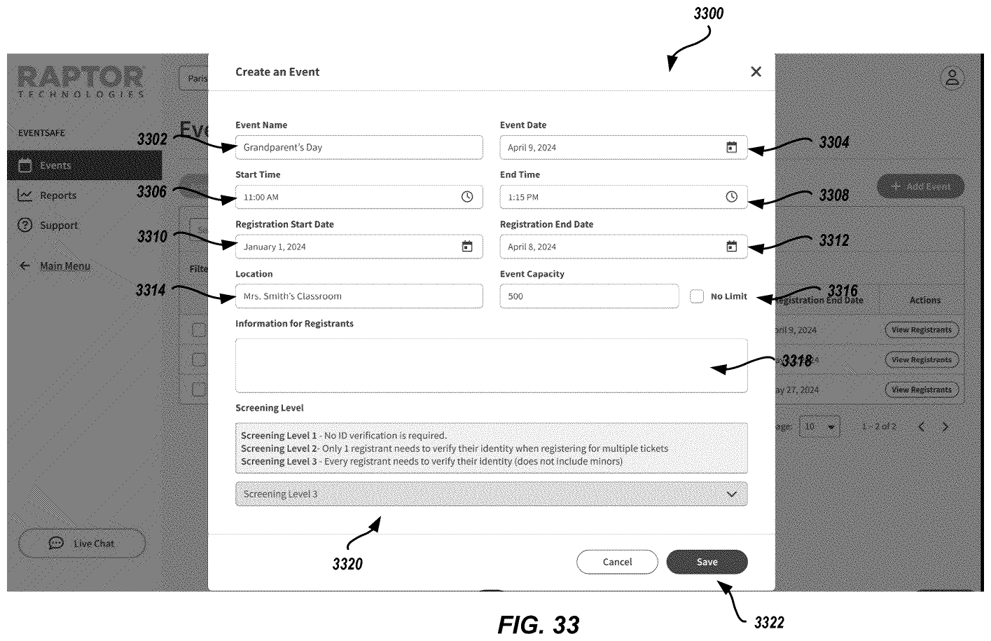

Referring to FIG. 33, in response to engaging the selectable element 2314, a user interface 3300 is presented that enables the user to enter details regarding the new event. The user interface 3300 includes a field 3302 for entering the event name, a field 3304 for specifying the event date, a field 3306 for specifying the event start time, a field 3308 for specifying the event end time, a field 3310 for specifying a date on which users can begin registering for the event, a field 3312 for specifying a date on which users can no longer register for the event, a field 3314 for specifying the location for the event, a field 3316 for specifying the capacity for the event, and a field 3318 for adding information that is to be provided to event registrants.

The user interface 3300 also includes a selectable element 3320 (e.g., a dropdown menu) for selecting a screening level for the new event. In some implementations, the selectable element 3320 enables the user to select a screening level for the event from two or more predetermined screening levels. In some implementations, the selectable element 3320 enables the user to select either “Screening Level 1,” “Screening Level 2,” or “Screening Level 3.” For events for which “Screening Level 1” is selected, there is no requirement to verify the identity of the participants registered for the event. For events for which “Screening Level 2” is selected, when a user is registering a group of multiple attendees for the event (e.g., multiple family members), the identity of only one user in the group of multiple attendees is required to be verified in order to register the entire group for the event. For events for which “Screening Level 2” is selected, the identity of every adult registered for the event must be verified.

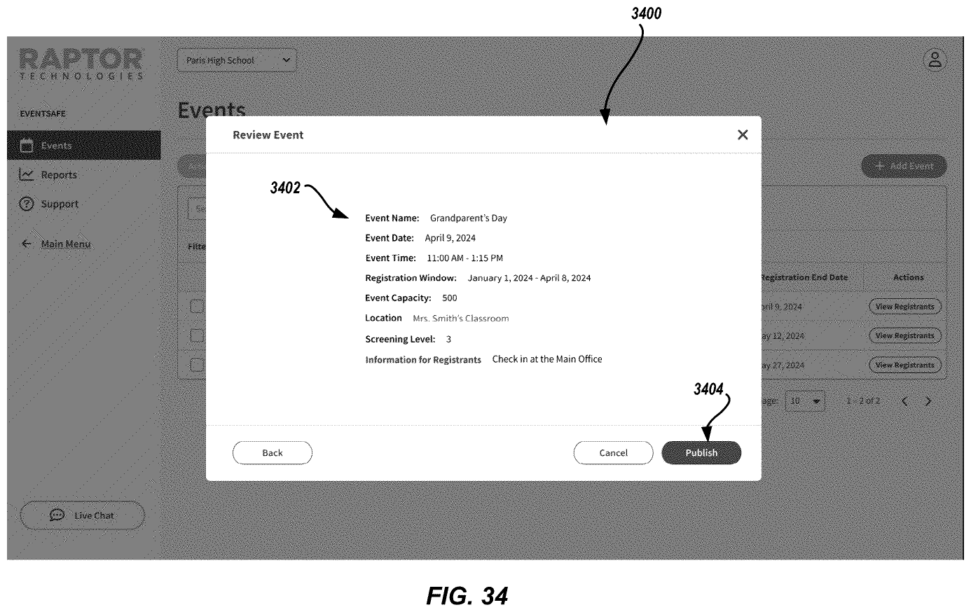

Once the user has completed entering the information for the new event using the selectable fields 3302-3320, the user can use a “Save” button 3322 displayed on the user interface 3300 to save the event. Referring to FIG. 34, in response to selection of the “Save” button 3322, a user interface 3400 depicting the event details 3402 is displayed for the user to review and confirm the event details. In response to determining that the event details 3402 for the new event are accurate, the user can select the “Publish” button 3404 displayed on the user interface 3400 to publish the event, which causes the event details to be transmitted to a central server device (e.g., server 140 of FIG. 1) and/or a data store (e.g., data store 160 of FIG. 1). Once the event is published, users of the platform can view and register for the event. In addition, once the event is published, the event is added to the list of events 2304 for the school displayed by the user interface 2300.

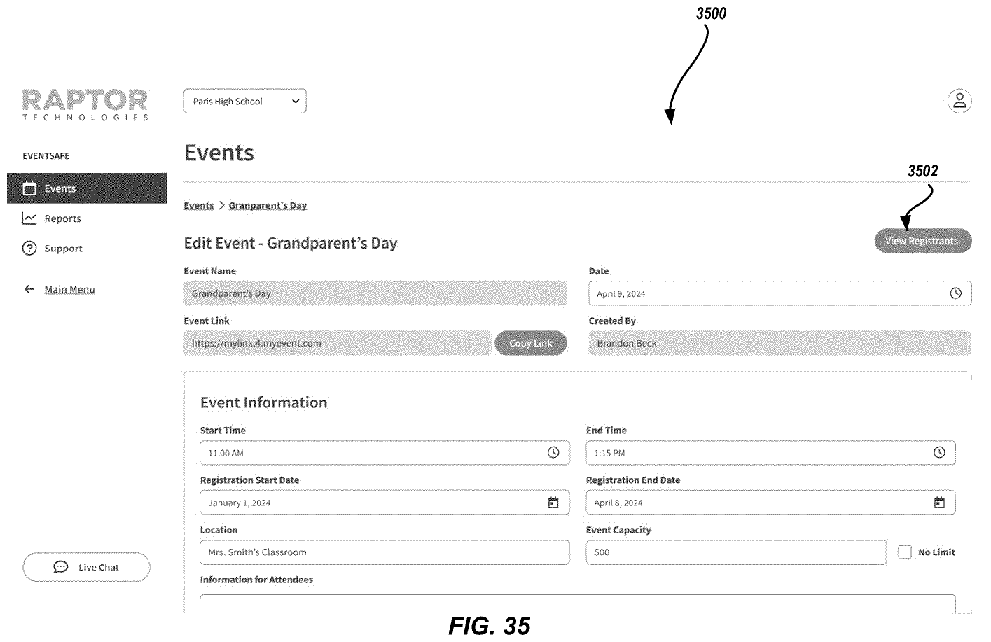

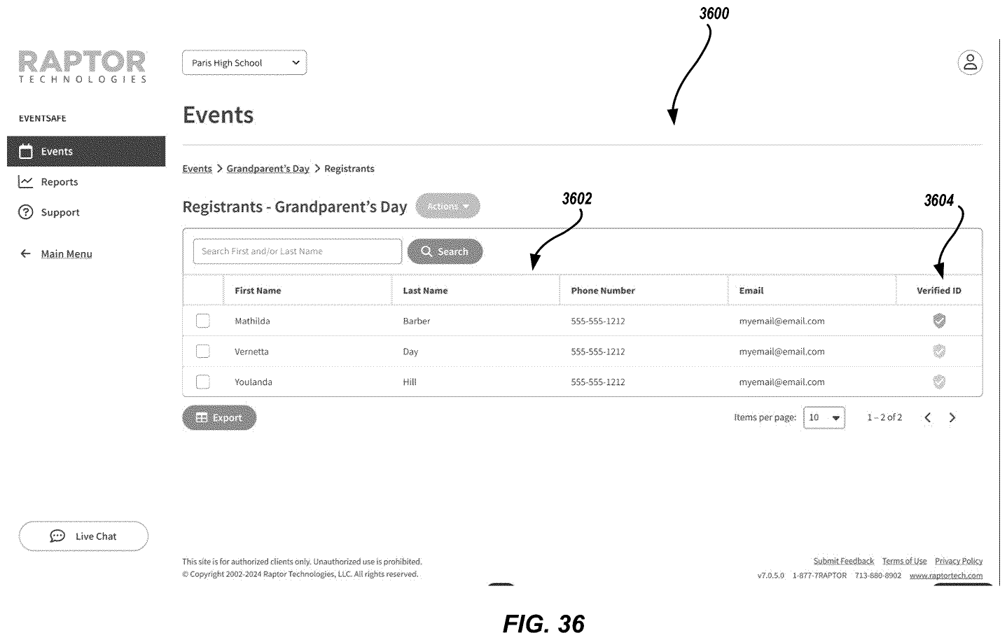

Referring back to FIG. 32, the user can select a “Details” element 2316, 2318, 2320 corresponding to a respective event 2306, 2308, 2309 in order to view and edit the details of the event. For example, referring to FIG. 35, in response to selecting the “Details” element 2316 for the “Grandparent's Day” event 2306, a user interface 3500 displaying the details of the “Grandparent's Day” event 2306 is presented to the user. The user interface 3500 can be used to edit one or more details of the “Grandparent's Day” event 2306. In addition, the user interface 3500 includes a selectable element 3502 that can be used to access a list of persons that have registered for the event 2306 (“registrants”). Referring to FIG. 36, in response to selection of selectable element 3502, a user interface 3600 is presented that includes a list 3602 of all users that have registered for the event 2306, including the contact information for each registrant. The user interface 3600 also includes, for each registered user, an indication 3604 of whether the identity of the respective user has been verified.

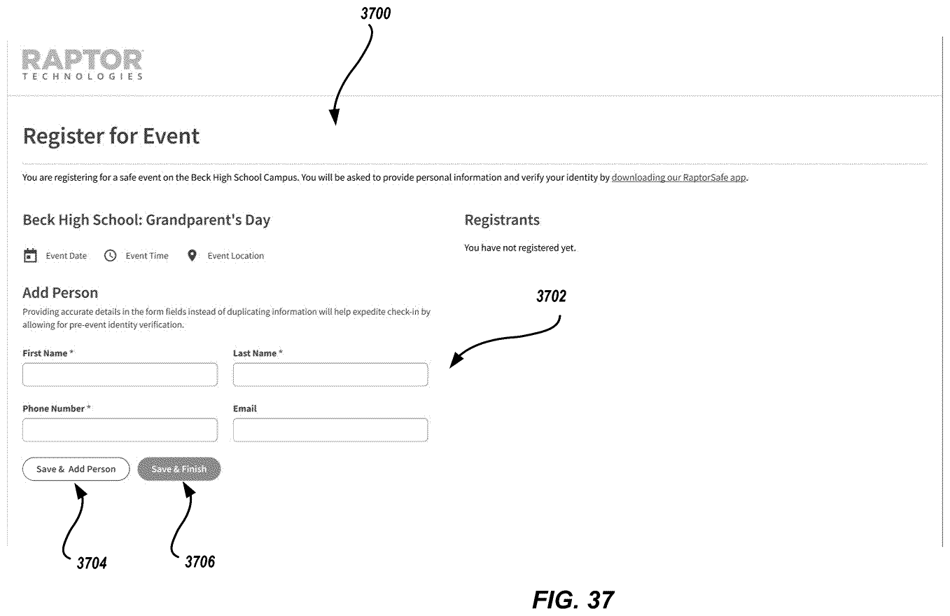

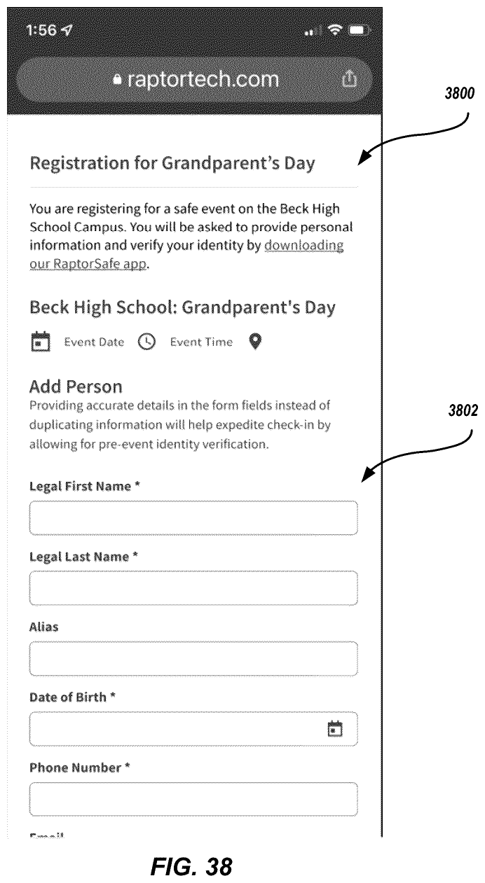

FIGS. 37 and 38 each depict example user interfaces 3700, 3800 for a user to register for an event (e.g., Grandparent's Day” event 2306). The user interfaces 3700, 3800 include fields 3702, 3802 for the user to enter information for a person to be registered for the event (e.g., first name, last name, phone number, email, date of birth, etc.). Referring to FIG. 37, once the information has been entered for the registrant, the user can select a “Save & Add Person” button 3704 in order to register another person for the event and enter the person's information. Once the user has finished entering the information for all of the people the user is registering for the event, the user can select the “Save & Finish” button 3706 to complete the registration process.

In response to selecting the “Save & Finish” button 3706, the registrants are added to the attendee list for the event and the information for the one or more registrants provided by the user is stored in a database (e.g., data store 160). In some implementations, in response to selecting the “Save & Finish” button 3706, a temporary access credential is sent to each of the one or more registrants. For example, a temporary access credential in the form of a scannable code (e.g., a barcode or QR code) can be sent to the email address of each registrant. In some implementations, for each registrant with an associated platform user account, the temporary access credential in the form of a scannable code (e.g., a barcode or QR code) is uploaded to the user's account and accessible from the user's account (e.g., using a mobile application).

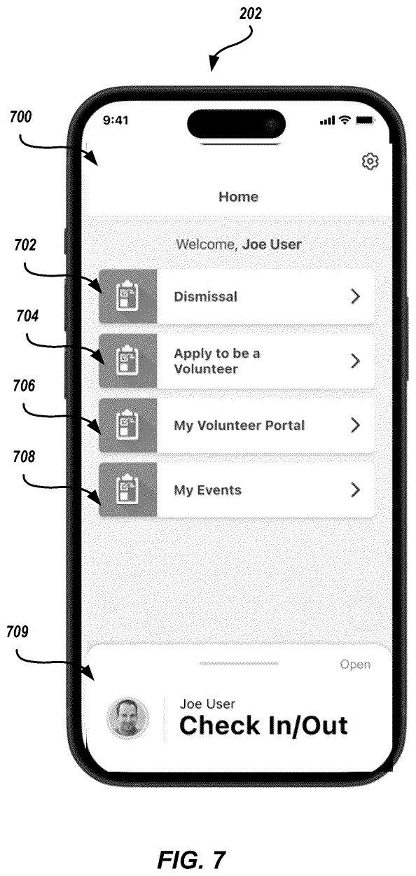

Referring back to FIG. 2, at step 228, the computing device 202 stores the school access credential. Referring to FIG. 7, the school access credential can be accessed using the selectable element 709 displayed in the user interface 700. For example, in response to selecting the selectable element 709, a digital access credential code is displayed by the computing device 202. In some implementations, digital access credential code displayed by the computing device 202 in response to selection of element 709 is a scannable code (e.g., QR code or barcode) that can be scanned by another computing device (e.g., using the camera of another phone or mobile tablet) to automatically verify the user's access credential. As described herein, the digital access credential code can be used to automatically verify the person's identity, for example, in order to determine the person's access privileges to one or more school facilities.

In some examples, the computing device 202 stores the school access credential to a digital wallet. A digital wallet (e.g., Apple Wallet, Google Wallet, Samsung Wallet, Dock Wallet) can also be referred to as an e-wallet or mobile wallet. A digital wallet is a virtual wallet in which a user can store digital identification documents and credentials. When arriving at a school facility, the user can scan the stored access credential at a computing system located at a school access point.

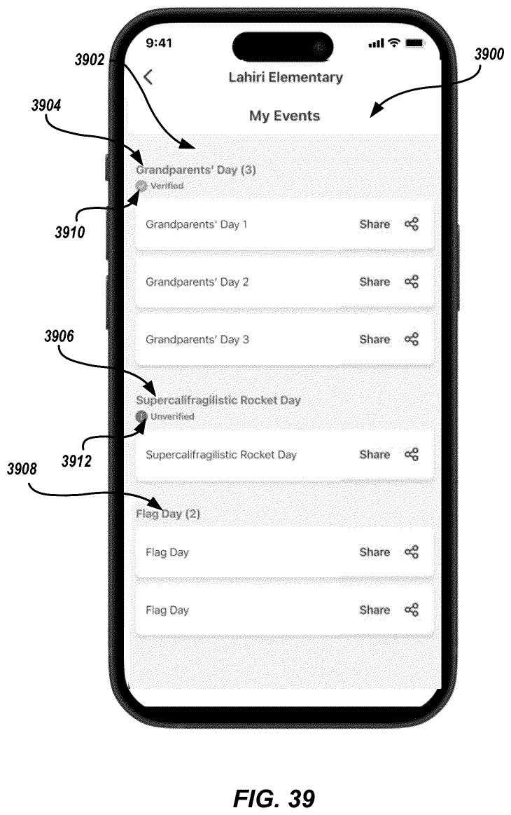

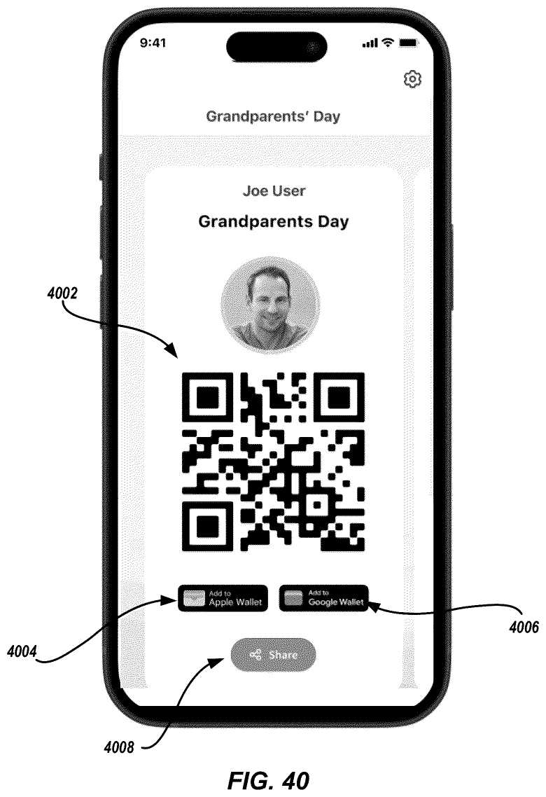

Referring to FIGS. 7 and 39, in response to selection of the “My Events” element displayed by the computing device 202 in user interface 700, the computing device 202 presents a user interface 3900 displaying a list 3902 of all events 3904, 3906, 3908 that the user is registered to attend. The user interface 3900 also includes an indication 3910, 3912 of whether or not the user's identity has been verified for the respective events. In response to selecting one of the events displayed on the user interface 3900, the computing device displays the user's digital access credential code for the event. For example, referring to FIGS. 39 and 40, in response to selecting the “Grandparent's Day” event 3904 displayed in the list 3902, the computing device 202 display the digital access credential 4002 for the user for the user to check into the event. As depicted in FIG. 40, the digital access credential 4002 is a scannable code (e.g., QR code or barcode) that can be scanned by another computing device at the event location in order to automatically verify the identify the user, verify that the user has registered for the event, and/or check the user into the event. The user interface 4000 displaying the digital access credential 4002 also includes selectable elements 4004, 4006 to enable the user to store the digital access credential 4002 to a digital wallet and a selectable element 4008 to enable the user to share the digital access credential 4002 (e.g., via SMS text message or email).

At step 230, the computing device 202 sends a student change request to the server device 140 to change one or more items of information related to a student associated with the guardian user. FIGS. 7 to 31 depict an example computing device executing a student change request.

The computing device 202 can provide, through the student management application, a user interface that enables a user to request a change in information for a student. The server device 140 receives the request from the computing device 202. A requested change for a student can include any of the following: assignment of a guardian to the student, removal of a guardian from the student, a change to a before-school activity, a change to an after-school activity, a change to a before-school arrival action, a change to an after-school dismissal action, or another type of change. A change to the after-school dismissal action can include assigning the student to a particular bus, assigning the student to a particular bus stop, assigning the student to a carpool, assigning the student to after-school care, assigning the student to an after-school activity, assigning the student to bicycle or walk home, or another type of after-school dismissal action.

FIGS. 7-10 depict an example computing device 202 executing a request for a student change in accordance with implementations of the present disclosure. Referring to FIG. 7, the computing device 202 can display a user interface 700 with selectable elements 702, 704, 706, 708 for accessing one or more features of the application. For example, the user interface 700 includes a selectable element 702 for accessing dismissal settings for one or more students associated with the guardian user, a selectable element 704 for accessing an application to volunteer at an event associated with a school, a selectable element 706 for accessing a volunteer portal containing information related to the user's volunteer activities, and a selectable element 708 for accessing one or more events that the user has registered to attend. The user interface 700 also includes a selectable element 709 that can be selected in order to display a code (for example, a QR code) that can be used to automatically check the user into or out of a school or event.

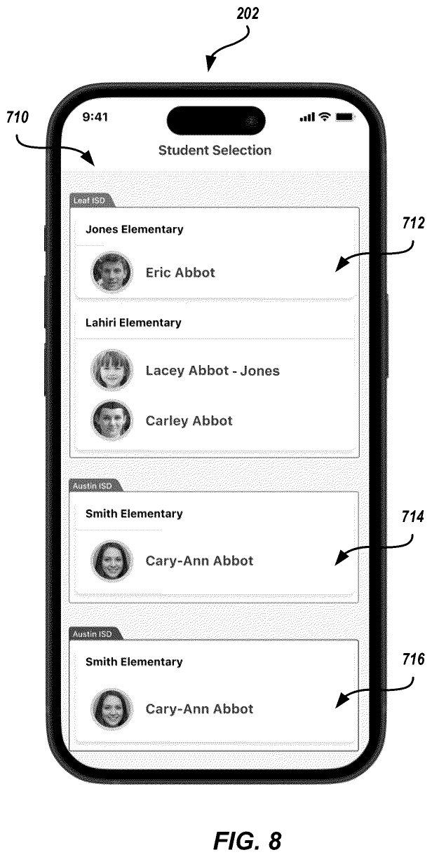

Referring to FIG. 8, in response to selecting element 702, a user interface 710 shows a list of students associated with a guardian user. For example, when the user is assigned to the guardian role, the user interface 710 shows a list of students for whom the user is an assigned guardian. In the example of FIG. 7, the students associated with the user attend three different schools in two different school districts, “Leaf ISD” and “Austin ISD”. The user interface 710 includes selectable elements for each of the schools. For example, the user interface 710 include selectable element 712 The user can select a school from the user interface 710.

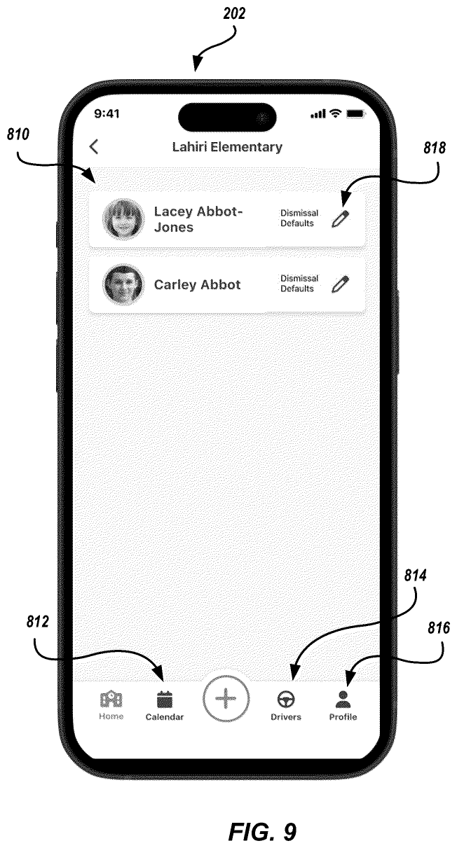

Referring to FIG. 9, in response to the user selecting a school in user interface 710, user interface 810 shows a list of the students who are associated with the user and who attend the selected school (e.g., “Lahiri Elementary”). The user interface 810 includes selectable options for editing information for students “Lacey Abbot-Jones” and “Carley Abbot” who each attend Lahiri Elementary. The options include editing a calendar 812, editing authorized drivers 814, and editing a student profile 816. The options also include editing dismissal defaults 818 for each of the students.

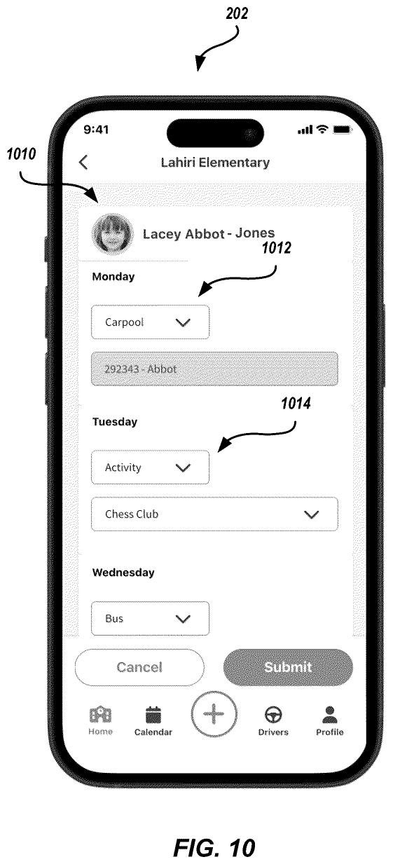

When the user selects an icon for an individual student, the computing device 202 can present editable information for the student. Referring to FIG. 10, in response to the user selecting the selectable icon 818 for editing dismissal defaults for student “Lacey Abbot-Jones,” a user interface 1010 shows default dismissal actions for Lacey Abbot-Jones. The user interface 1010 includes fields (e.g., field 1012) that enable the user to change dismissal actions for Lacey Abbot-Jones. The user can change the default dismissal action for Lacey for each day of the week.

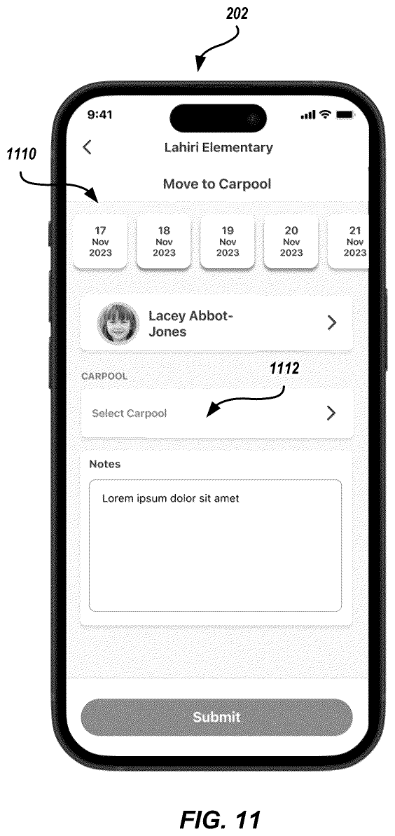

FIGS. 11-19 depict an example computing device executing a change to a student carpool schedule in accordance with implementations of the present disclosure.

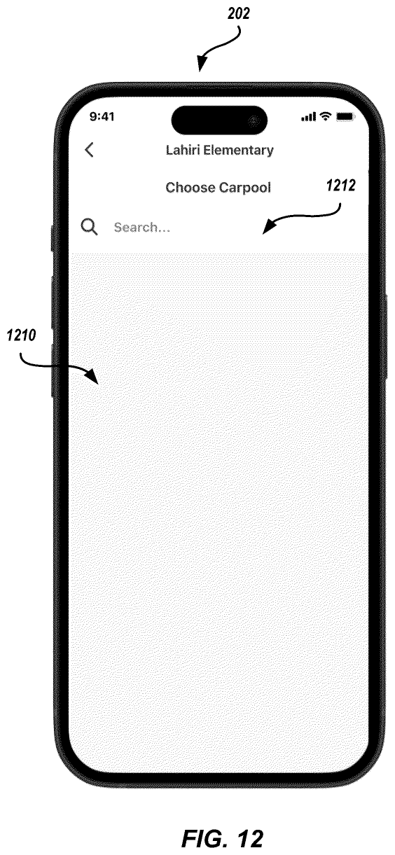

Referring to FIG. 11, when the user selects “Carpool” from the field 1012 of the user interface 1010, the computing device 202 presents user interface 1110 that enables the user to change assigned carpools(s) for Lacey Abbot-Jones. The user interface 1110 includes a selectable element 1112 for selecting a particular carpool. When the user selects the “Select Carpool” element 1112, the computing device 202 presents user interface 1210, shown in FIG. 12.

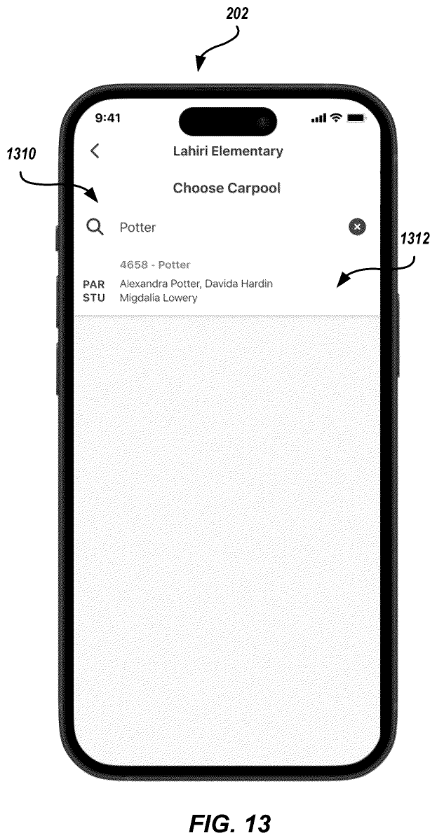

Referring to FIG. 12, a user interface 1210 includes a search field 1212 that enables the user to search for carpools. Referring to FIG. 13, in response to the user entering a search term (e.g., “Potter”) in the search field 1211 of user interface 1210, a user interface 1310 presents search results 1312 for carpools at Lahiri Elementary. The search results include carpool “4658-Potter.” The search results 1312 display a list of students assigned to the carpool “4658-Potter.” The user can select a search result from the search results 1312 displayed on user interface 1310.

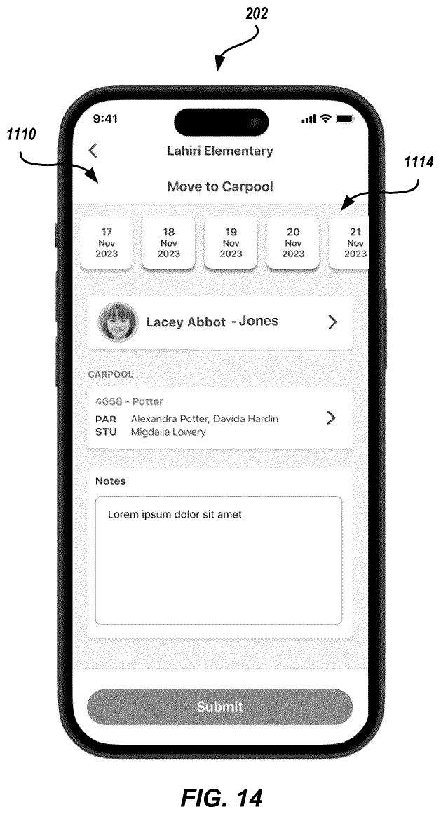

Referring to FIG. 14, after the user selects a particular carpool (e.g., the “4658-Potter” carpool) from the search results 1312, the user interface 1110 is updated to indicate that Lacey Abbot-Jones is to be assigned to the selected carpool. The user interface 1110 includes selectable icons 1114 for various dates on which the student Lacey Abbot-Jones is to be assigned to the selected carpool. The user can select a single date or multiple dates to assign the selected student to the selected carpool.

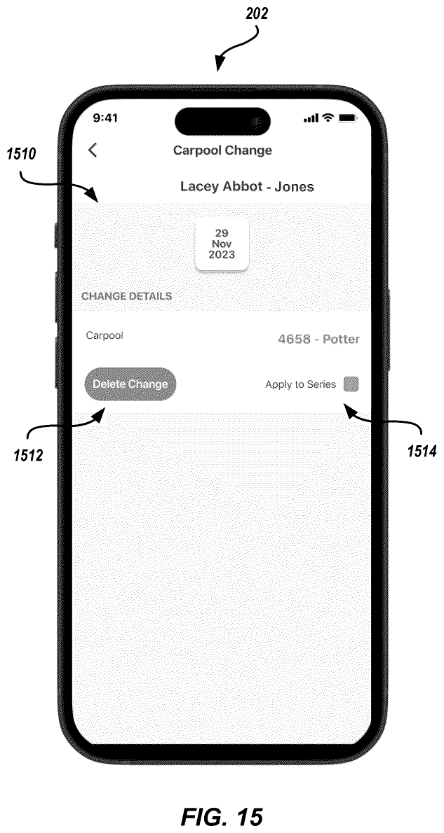

Referring to FIG. 15, after the user inputs a change to the carpool, a user interface 1510 shows a summary of the change and applicable dates. Specifically, the user interface 1510 shows that Lacey Abbot-Jones is assigned to the “4658-Potter” carpool on Nov. 29, 2023. The user interface 1510 includes selectable options for deleting the change 1512 or applying the change to a series of dates 1514.

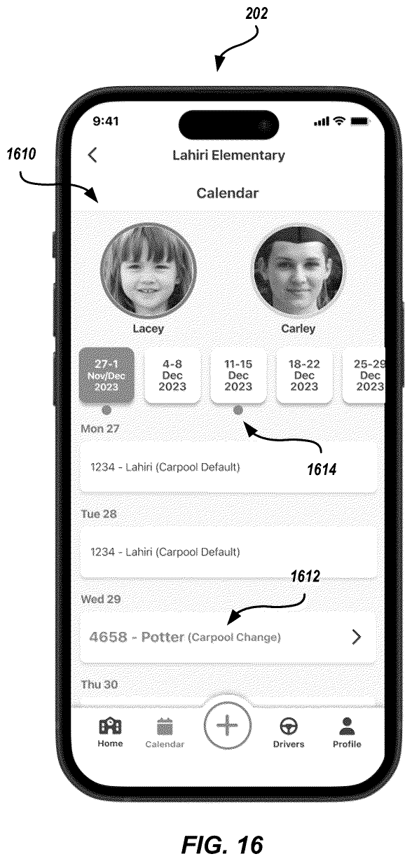

Referring to FIG. 16, a user interface 1610 shows a carpool schedule for the student Lacey for the week of November 27 following the updated carpool assignment described in reference to FIGS. 11-15. The entry 1612 for November 29 is highlighted, indicating that the assigned carpool of “4658-Potter” for November 29 is different from the default carpool. Additionally, dates ranges which include one or more dates on which the carpool is different from the default carpool are indicated by a dot icon 1614.

In some examples, the server device 140 can notify a guardian when a student is added to or removed from the carpool for which the guardian is responsible. The server device 140 can identify, from the data store 160, an electronic contact address for the guardian responsible for the newly assigned carpool. In the example of FIG. 16, the server device 140 can identify an electronic contact address for the “Potter” carpool. The server device 140 can send, a notification that the student “Lacey Abbot-Jones” is newly assigned to the Anderson carpool for November 29 to the electronic contact address for one or more guardians assigned to the “Potter” carpool.

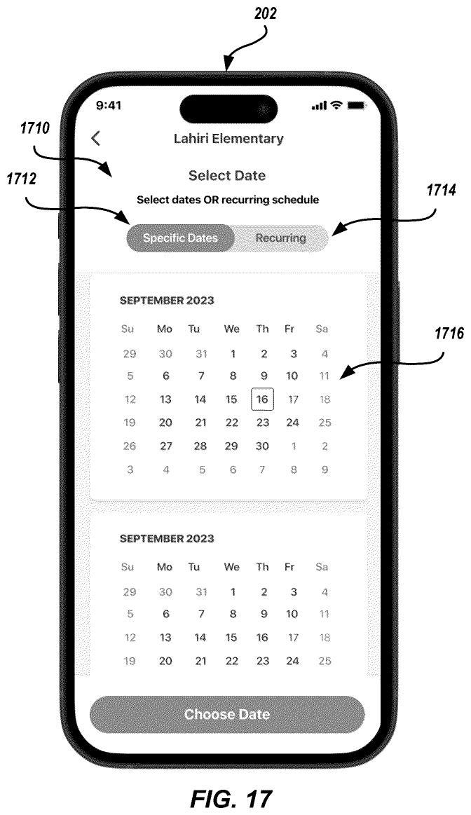

Referring to FIG. 17, a user interface 1710 enables the user to make changes to dismissal actions for multiple dates. The dates can be selected individually, or the user can set up a recurring schedule. For example, in response to user selection of option 1712 for “Specific Dates,” the computing device 202 presents a calendar 1716 from which the user can select individual dates for assigning the student to a particular dismissal activity. In response to user selection of option 1714 for “Recurring,” the computing device 202 can present a user interface that allows the user to create a recurring (e.g., weekly, monthly) schedule for the student.

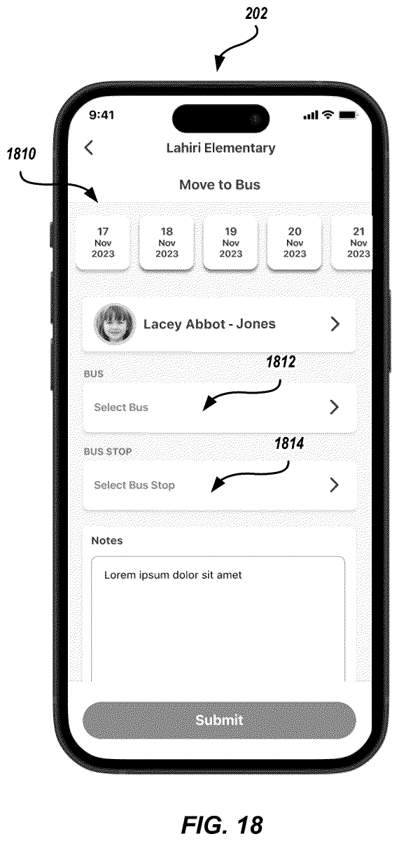

FIGS. 18-23 depict an example computing device executing a change to a student bus schedule in accordance with implementation of the present disclosure.

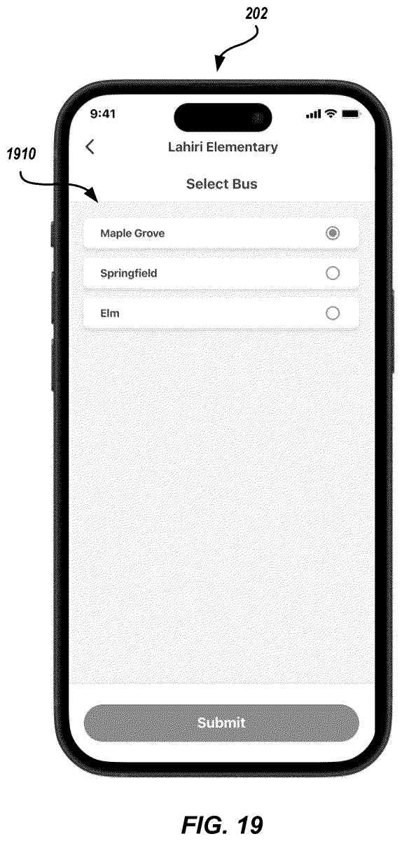

Referring to FIG. 18, when the user selects “Bus” from the field 1012 of user interface 1010 shown in FIG. 10, the computing device 202 presents user interface 1810 that enables the user to assign a bus for Lacey Abbot-Jones. Referring to FIG. 19, in response to the user selecting the “Select Bus” icon 1812 in user interface 1810, the computing device 202 displays a user interface 1910 includes a list of selectable icons for buses that Lacey Abbot-Jones is eligible to be assigned to. In some examples, the server device 140 obtains the list of eligible buses from the data store 160. For example, the student profile 123 for Lacey Abbot-Jones can include a list of buses to which Lacy is permitted to be assigned.

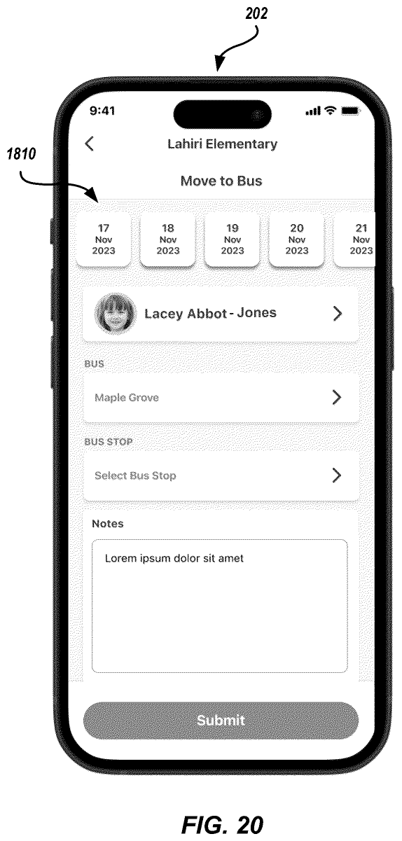

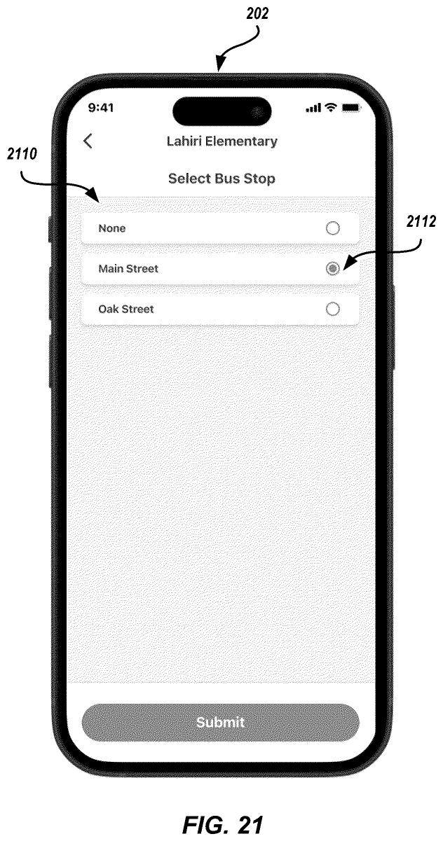

Referring to FIG. 20, after the user selects a particular bus, the user interface 1810 is updated to show that Lacey Abbot-Jones is to be assigned to the selected bus (“Maple Grove”). The user interface 1810 also includes a “Select Bus Stop” icon 1814 that enables the user to select a bus stop at which Lacy Abbot is to be delivered. Referring to FIG. 21, in response to the user selecting the “Bus Stop” icon 1814 in user interface 1810, the computing device 202 a user interface 2110 includes a list of selectable icons for bus stops to which Lacey Abbot-Jones is eligible to be delivered. In some examples, the server device 140 obtains the list of eligible bus stops from the data store 160.

In some examples, the student profile 123 for Lacey Abbot-Jones can include a list of bus stops to which Lacey is permitted to be assigned. In some examples, the server device 140 determines the list of eligible bus stops based on address information for Lacey Abbot-Jones. For example, the student profile 123 for Lacy Abbot can include a home address, and the server device 140 can select bus stops that are within a designated maximum range (e.g., a quarter-mile) from the home address.

In some examples, the list of eligible bus stops is dependent on the selected bus. For example, the Maple Grove bus selected using user interface 1910 can have an assigned route, and can be associated with a list of bus stops along the assigned route at which the bus is eligible to stop. The user can select a bus stop from the list of eligible bus stops assigned to the selected bus by selecting an icon from the user interface 2110. In the example of FIG. 21, the user selects icon 2112 to assign Lacey to the “Main Street” bus stop along the “Maple Grove” bus route.

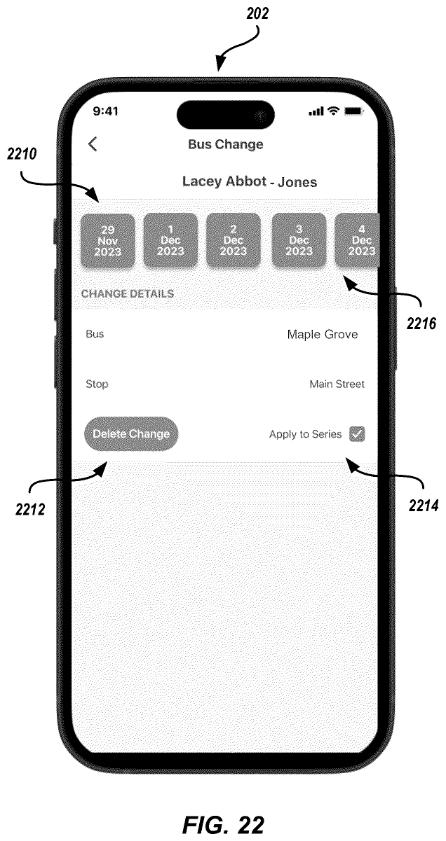

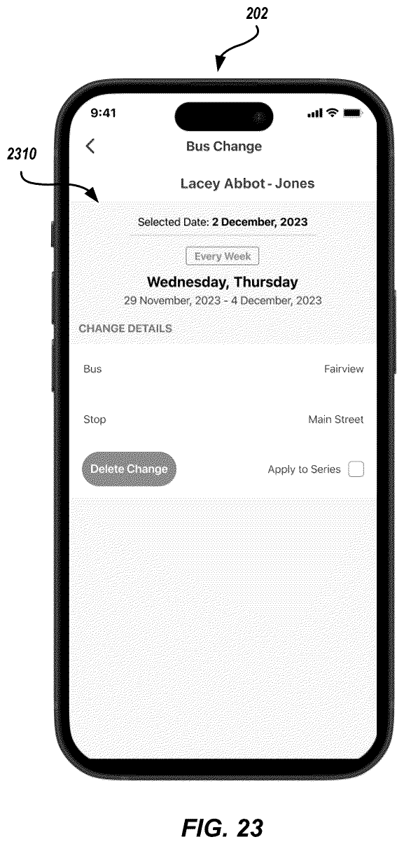

Referring to FIG. 22, after the user selects a bus and bus stop, the computing device 202 displays a user interface 2210 that shows a summary of the bus and bus stop assignments and date icons 2216 to select the applicable dates for the updated assignment. The user interface 2210 includes selectable options for deleting the change 2212 or applying the change to a series of dates 2214. Referring to FIG. 23, after the user selects to apply the change to a series of dates 2214 (e.g., selected using date icons 2216), a user interface 2310 shows the summary of the updated bus assignment and the applicable dates for the updated assignment.

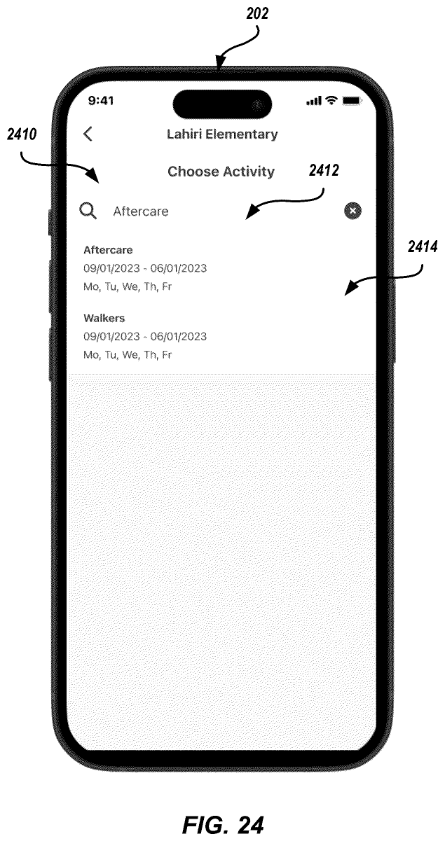

FIGS. 24-27 depict an example computing device executing a change to a student after school activity schedule in accordance with implementations of the present disclosure.

Referring to FIG. 24, when the user selects “Activity” from the field 1014 of user interface 1010 shown in FIG. 10, the computing device 202 presents a user interface 2410 that enables the user to change after school activities assigned for Lacey Abbot-Jones. The user interface 2410 includes a search field 2412 that enables the user to search for activities. After the user enters a search query (“Aftercare”) in the search field 2412, the user interface 2410 presents search results 2414 (“Aftercare” and “Walkers”) for activities at Lahiri Elementary corresponding to the search query. The user can select a search result 2414 from the user interface 2410. In some examples, in response to the user entering a search query in the search field 2412, the server device 140 obtains a list of eligible activities from the data store 160, and executes the search query based on the obtained list. For example, the student profile 123 for Lacey Abbot-Jones can include a list of activities to which Lacy is permitted to be assigned and the user interface 2410 can then present the search results for activities that match the query and are included in the list of permitted activities.

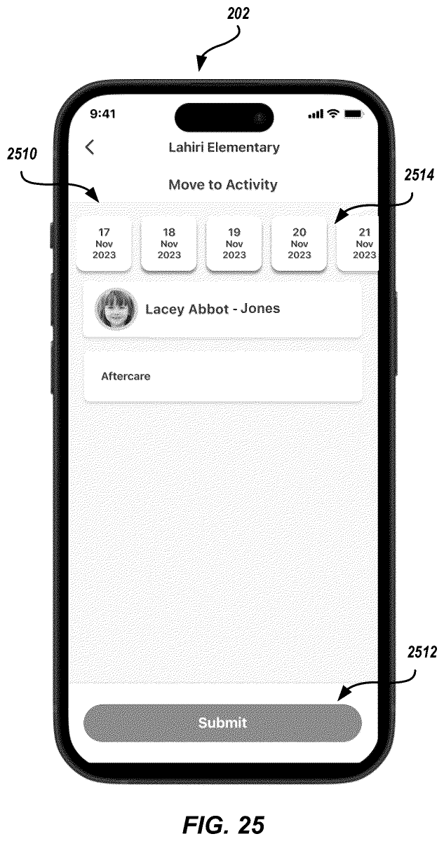

Referring to FIG. 25, after the user selects a particular activity from the search results 2414, the computing device 202 displays a user interface 2510 that shows that Lacey Abbot-Jones is to be assigned to the selected activity of “Aftercare.” The user interface 2510 includes selectable icons 2514 for various dates and the user can select a particular date or multiple dates for the assigned activity using the icons 2514.

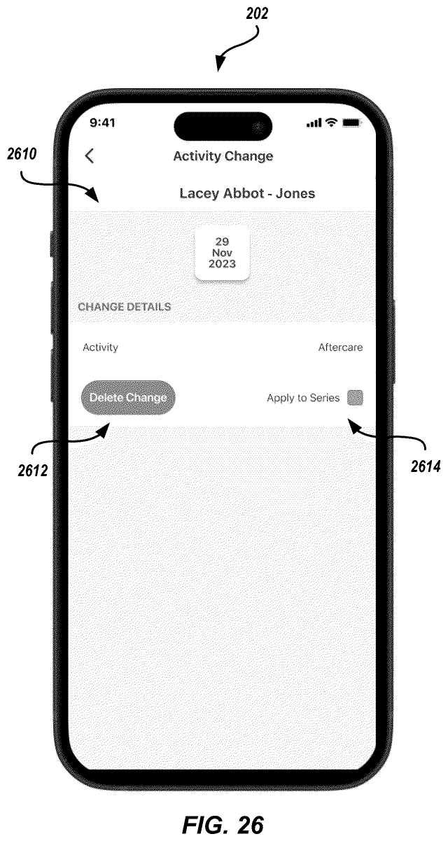

Referring to FIG. 26, after the user submits a change to the activity using icon 2512 of the user interface 2510, the computing device 202 displays a user interface 2610 that shows a summary of the assigned activity and applicable date(s) for the assigned activity. The user interface 2610 includes selectable options for deleting the change 2612 or applying the change to a series of dates 2614.

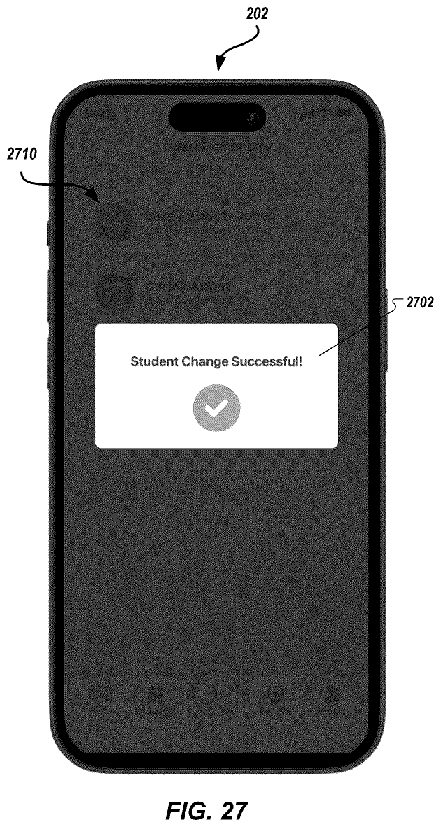

Referring to FIG. 27, after a change is made to a student dismissal action, as described above in reference to FIGS. 11-26, a user interface 2710 confirms the student change. The user interface 2710 presents a notification 2702 indicating that the student change was successful.

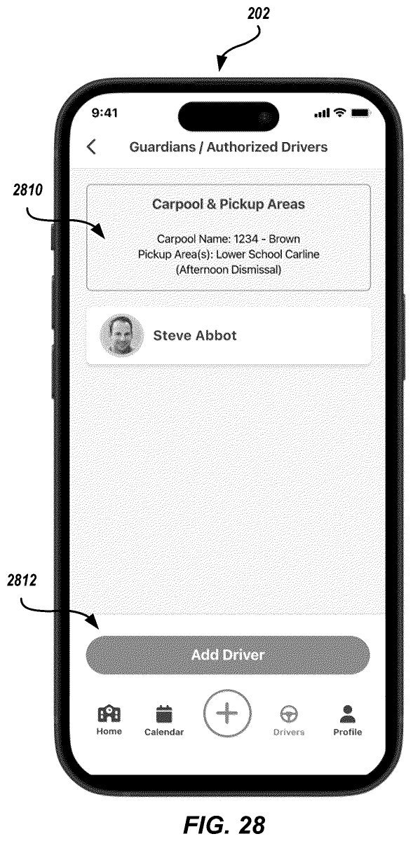

FIGS. 28-31 depict an example computing device 202 executing a change to guardians and/or drivers authorized to pick up a student from school in accordance with implementations of the present disclosure.

Referring to FIGS. 8, 9, and 28, in response to selecting a particular student associated with a guardian user on user interface 710 and the authorized drivers icon 814, the computing device 202 displays a user interface 2810 that shows a list of authorized drivers assigned to the selected student. The user interface 2810 includes a selectable icon 2812 that enables the user to add a driver assigned to the student.

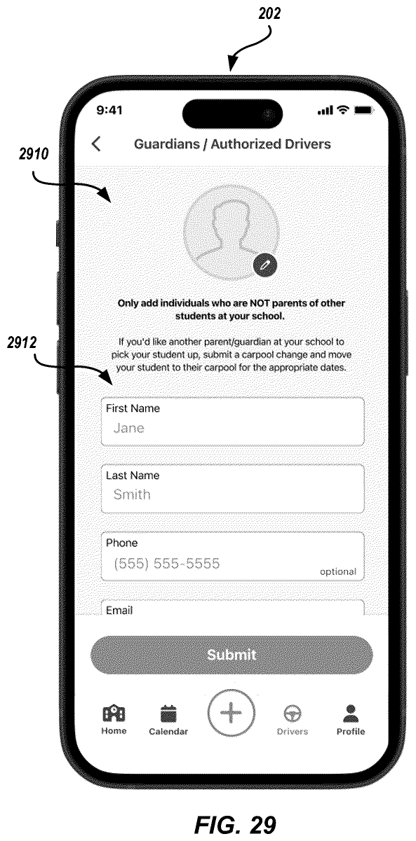

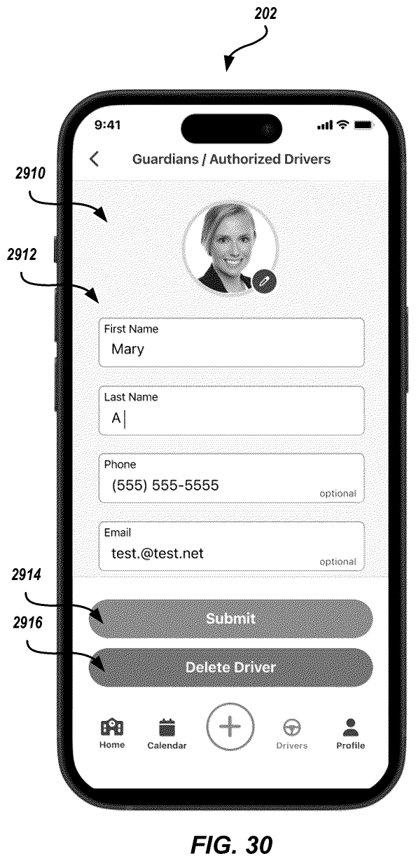

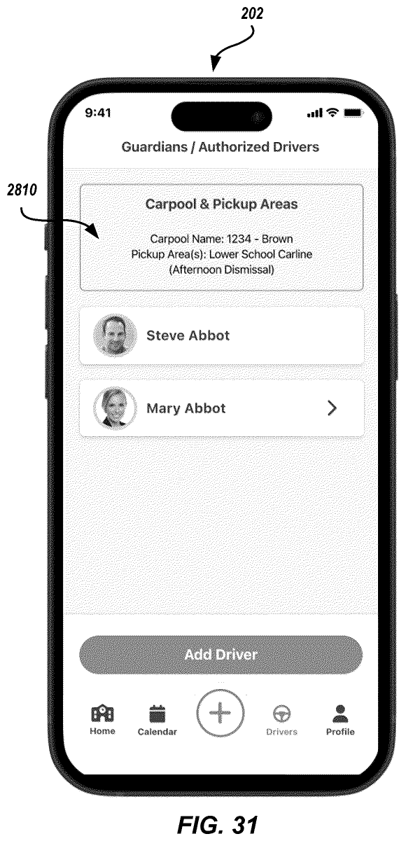

Referring to FIG. 29, after selecting the icon 2812, the computing device 202 displays a user interface 2910 that includes fields 2912 for inputting information for a new driver that is authorized to pick up the selected student from school. For example, referring to FIG. 30, the user has input information for the new driver Mary Abbot into the fields of the user interface 2910. Once the information for the new authorized driver has been input in filed 2912, the user can select a “Submit” icon 2914 to assign the new driver to the selected student or can select a “Delete Driver” icon 2916 to prevent assignment of the new driver to the selected student. In some examples, the user can select to add the new driver as a permanent driver or as a temporary driver. For example, the user can assign the new driver to pick up a student only on particular dates, or to pick up the student on any date. Referring to FIG. 31, after adding the new driver, the user interface 2810 shows the list of authorized drivers, including the newly added driver Mary Abbot.

Referring back to FIG. 2, at step 232, the server device 140 provides the student change to the data store 160. In response to receiving the request, the server device 140 can perform the requested change by updating data in the data store 160. For example, in response to receiving the request, the server device 140 can update information in a student profile 123 of the student.

At step 234, the server device 140 sends a student change confirmation to the computing device 202. For example, referring to FIG. 27, the student change confirmation can include a notification 2702 indicating that the student change was successful.

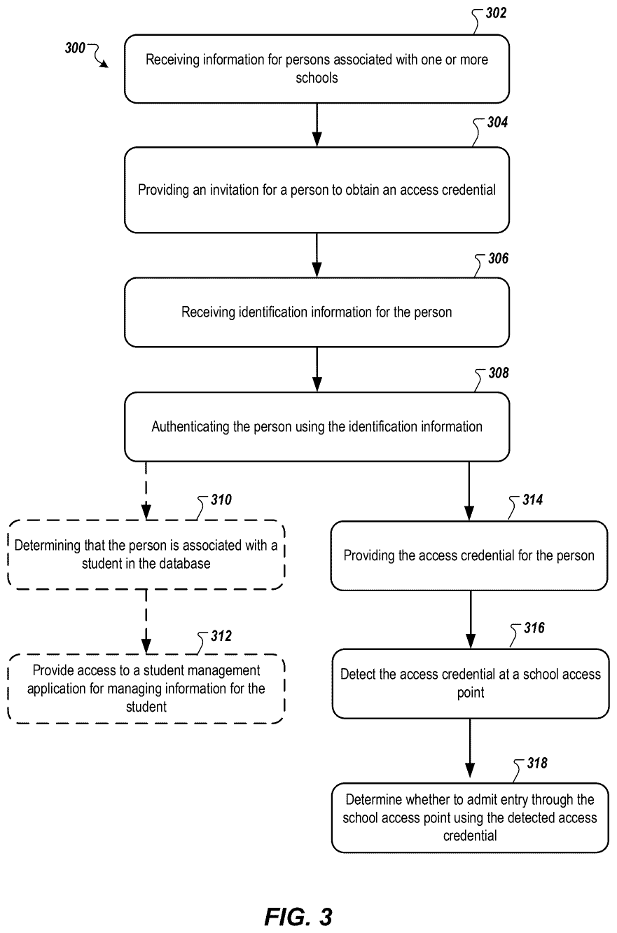

FIG. 3 is a flow chart of an example process 300 for accessing a student management application in accordance with implementations of the present disclosure.

The process 300 includes receiving, from a plurality of schools, information for a plurality of persons associated with one or more schools of a plurality of schools (302). The information can be received from one or more computer systems associated with the schools. For example, the information can be received from the computer system 132a associated with the school 142a, from the computer system 132b associated with the school 142b, from the computer system 132c associated with the school 143b, or any combination thereof. The received information can indicate, for each person of the plurality of persons, that the person is assigned to at least one role of a plurality of roles at a particular school 142. The plurality of roles can include a visitor role, a faculty role, a staff role, a volunteer role, a guardian role, and a student role. In some examples, each person assigned to the guardian role is associated with at least one person assigned to the student role.

The process 300 includes sending, to an electronic device, an invitation for a person of the plurality of persons to obtain an access credential (304). The access credential is a digital credential that is configured to enable the person to access facilities of schools within the group of schools. In some examples, the process 300 includes identifying, from the database, an electronic contact address for the person, and sending the invitation to the electronic contact address for the person. The electronic address can include, for example, a telephone number or email address.

The process 300 includes receiving, from the electronic device, identification information for the person (306). In some examples, the identification information includes data representing an identification document for the person. The identification document can be, for example, a driver's license, passport, student identification or other identification document. The data representing the identification document can be, for example, a photograph or scan of the identification document. In some examples, the process 300 includes storing, in the database, the data representing the identification document.

In some examples, the identification information includes an image of the person. In some examples, the identification information includes multiple images, or video, of the person. In some cases, the image(s) are generated by the computing device 202. In some examples, the image(s) depict the person moving in a prescribed manner (e.g., turning their head). By obtaining live images and/or images depicting the person moving in the prescribed manner, the server device 140 can verify that the person requesting the digital credential is the same person represented in the identification document.

The process 300 includes authenticating the person using the identification information (308). In some examples, authenticating the person includes determining that the data representing the identification document for the first person satisfies criteria for matching the received images of the first person.

In some examples, authenticating the person includes performing liveness detection on the one or more images generated by the camera of the electronic device. Liveness detection can be performed to verify that the one or more images generated by the camera of the electronic device depict a live person, and not a photograph or recorded video.

In some examples, authenticating the person includes performing a screening for the person. The screening can be performed using information received at step 302 of the process 300. In some examples, the screening is performed using the data representing the identification document for the person. The screening can include, for example, a criminal background check, a motor vehicle records check, an industry ban check, a fraud screening, and other types of screenings.

In some implementations, the process 300 includes determining that the person is associated with a student in the database (310). For example, the process 300 can include determining that the person is assigned to the guardian role and that the person is associated with at least one person who is assigned to the student role. The determination can be made, for example, based on the information received from the computer systems 132 associated with the schools 142 at step 302 of the process 300.

The person assigned to the guardian role can be associated with any number of persons assigned to the student role. In some examples, the person assigned to the guardian role is associated with two or more students who attend the same school. In some examples, the person assigned to the guardian role is associated with two or more students who attend different schools within the group of schools. In some examples, the person assigned to the guardian role is associated with two or more students who attend different schools that are each associated with different respective groups of schools (e.g., different school districts or different school systems).

The process 300 includes providing, to the electronic device, access to a student management application (312). For example, in response to determining that the person is associated with a student, the process can include providing, to the computing device 202, access to a student management application. Access to the student management application enables the person to request changes to information in the database for the student. For example, as illustrated in FIGS. 7 to 31, changes can be requested by authorized guardian users to student information related to carpool assignments, authorized drivers, after school activities, bus assignments, bus stop assignments, or any combination thereof.

The process 300 includes providing the access credential to the person (314). The access credential is a digital credential that is provided in response to receiving the identification information. In some examples, the digital credential is generated in response to determining that the received identification information satisfies criteria for matching information stored in the database for the person. In some examples, the digital credential is generated in response to performing the screening for the person. In some examples, the digital credential is generated in response to determining that the data representing the identification document for the person satisfies criteria for matching the image(s) of the person. For example, the server device 140 can compare an image on the identification document (e.g., a driver's license photograph) to the captured image(s) of the person provided by the computing device 202. In response to determining that the image on the identification document matches the captured image(s) within a threshold similarity, the server device 140 can generate the digital credential.

The process 300 includes detecting the access credential at a school access point (316). For example, in order to gain entry to a school, the user can present the access credential at a computing system located at a school access point using a computing device displaying the access credential. In some implementations, the computing system can present the access credential to a scanning device in order to verify the person's access permissions.

The process 300 includes determining whether to admit entry through the school access point using the detected access credential (318). The computing system can determine, using the scanned access credential, whether the user is permitted to access the school facility. In some examples, the computing system identifies the role(s) of the user indicated by the digital credential and determines, based on the indicated roles(s), whether the user is permitted to access the school facility at the school access point. The computing system can determine whether to admit entry based on access criteria for the school access point.

In an example scenario, a first user who is a guardian and a contractor scans a digital credential at a computing system positioned at a particular access point of a school that is designated for contractor entry only. The computing system determines, using the digital credential, that the first user is assigned to both the guardian role and the contractor role. The computing system determines that the first user is permitted to enter the school through the particular access point in response to determining that the access criteria is satisfied due to the first user being assigned to the contractor role.

In response to determining that the first user is permitted to enter the school through the particular access point, the computing system can perform one or more actions. The actions can include, for example, unlocking a door, maintaining a door unlocked, changing a status light (e.g., from red to green), determining not to activate an alarm, and/or other actions.

Next, a second user who is a guardian only scans a digital credential at the computing system, and the computing system determines that the user is assigned to only the guardian role. The computing system determines that the second user is not permitted to enter the school through the particular access point in response to determining that the access criteria is not satisfied due to the second user being assigned to the guardian role and not to contractor role.

In response to determining that the second user is not permitted to enter the school through the particular access point, the computing system can perform one or more actions. In some cases, the actions include preventing the person from proceeding through the access point. The actions can include, for example, locking a door, maintaining a door locked, changing a status light (e.g., from green to red), activating an alarm, and/or other actions. In some implementations, if a user's identity cannot be automatically confirmed or the user is identified as not being permitted through a particular access point, an alert is generated to prompt a staff member to review and confirm the user's identity and access privileges.

In some examples, in response to detecting the access credential at the access point, the computing system can update information in the data store 160. For example, the computing system can provide an update to the data store 160 indicating that the access credential was detected at the access point. In some examples, the update indicates whether or not the access criteria was satisfied and/or whether or not the user entered through the access point. In this way, the data store 160 can store data indicating entry and departure times for various users. The data store can therefore track occupancy of school facilities over time.

The order of operations in the process 300 described above is illustrative only, and can be performed in different orders. For example, the server device 140 can provide the access to the student management application at the same time as, before, or after the server device 140 provides the access credential. In some examples, some steps can be performed by the server device 140, and other steps can be performed by another computing device such as the devices 102, 104, 108.

FIGS. 4A, 4B, 5A, 5B, 5C, and 5D depict an example computing device 202 obtaining a digital school credential in accordance with implementations of the present disclosure.

Referring to FIG. 4A, an example computing device 202 executes an application 120 in accordance with implementations of the present disclosure. In the example of FIG. 4A, a user (e.g., user 112) has launched the application 120 on the computing device 202. A user interface 404 of the application 120 is presented on the computing device 202. The user interface 404 includes a field 406 for entering a telephone number. Upon entry of the telephone number, the computing device 202 sends the telephone number to the server device 140.

Referring to FIG. 4B, the application 120 presents a user interface 408 including a field 418 for inputting the SMS code. When the user inputs the SMS code and selects the “Next” button 422, the computing device 202 sends the SMS code to the server device 140 for verification.

Referring to FIG. 5A, the user's telephone number 502 is added to the user's profile in the data store 160. The telephone number 502 then appears in the user interface 508 when the user views their profile on the computing device 202.

For example, referring to FIG. 5B, a user interface 510 includes a field 512 that enables the user to input an email address. Referring to FIG. 5C, after the user inputs the email address, the server device 140 sends a verification link to the email address.

Referring to FIG. 5D, the user's email address 522 is added to the user's profile in the data store 160. The email address 522 then appears in the user interface 520 when the user views their profile on the computing device 202.

Referring to FIG. 5E, a user interface 515 is presented on the computing device 202 to prompt a user to capture an image of the user's identification document using a camera of the computing device 202.

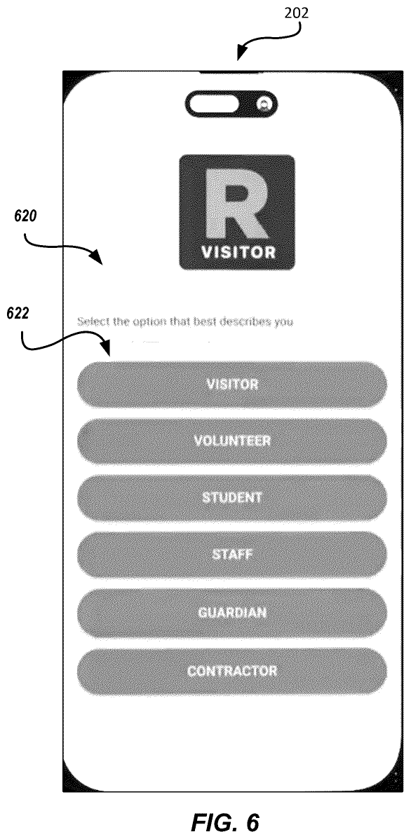

Referring to FIG. 6, the computing device 202 presents a user interface 620. The user interface 420 includes selectable elements 622 for different roles. The roles include “visitor,” “volunteer,” “student,” “staff,” “guardian,” and “contractor.” The roles can be presented based on previous approval and/or enrollment of the user for the particular roles. For example, based on information received from the schools 142, the server 140 may create, for a particular user, multiple profiles stored in the data store (e.g., a guardian profile, visitor profile, a contractor profile). When the particular user logs into the application, the user interface 620 can present selectable elements for roles of “guardian,” “visitor,” and “contractor.” In this example, the user interface 620 will not present selectable elements for roles of “student,” “staff,” or “volunteer,” since the user has not been approved for those roles, according to the information provided by the schools 142, and does not have profiles for those roles stored in the data store 160.

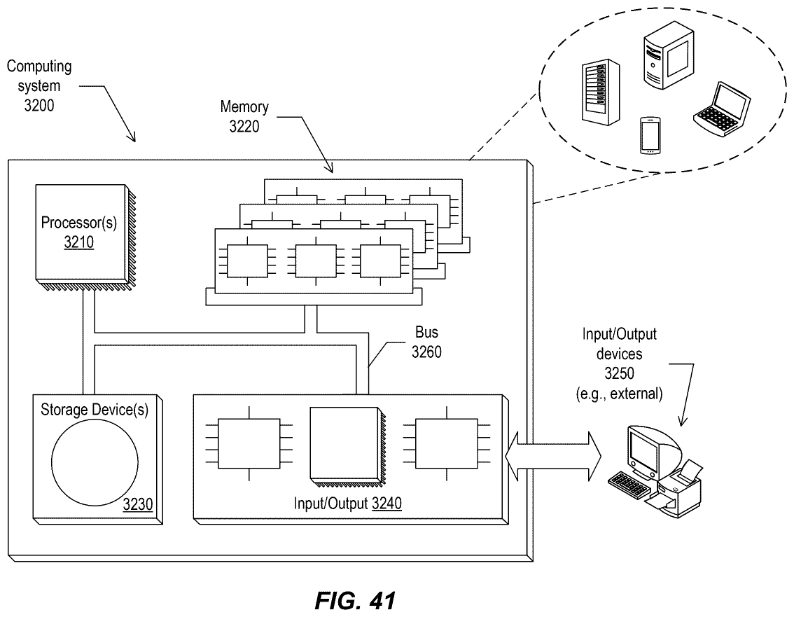

FIG. 41 depicts an example computing system 3200 in accordance with implementations such as those of the present disclosure. The system 3200 can be used for any of the operations described with respect to the various implementations discussed herein. For example, the system 3200 can be included, at least in part, in one or more of the computing devices 102, 103, 104, 105, 108 or the server device(s) 140 described herein. The system 3200 can include one or more processors 3210, a memory 3220, one or more storage devices 3230, and one or more input/output (I/O) devices 3250 controllable via one or more I/O interfaces 3240. Two or more of the components 3210, 3220, 3230, 3240, or 3250 can be interconnected via at least one system bus 3260, which can enable the transfer of data between the various modules and components of the system 3200.

The processor(s) 3210 can be configured to process instructions for execution within the system 3200. The processor(s) 3210 can include single-threaded processor(s), multi-threaded processor(s), or both. The processor(s) 3210 can be configured to process instructions stored in the memory 3220 or on the storage device(s) 3230. The processor(s) 3210 can include hardware-based processor(s) each including one or more cores. The processor(s) 3210 can include general purpose processor(s), special purpose processor(s), or both.

The memory 3220 can store information within the system 3200. In some implementations, the memory 3220 includes one or more computer-readable media. The memory 3220 can include any number of volatile memory units, any number of non-volatile memory units, or both volatile and non-volatile memory units. The memory 3220 can include read-only memory, random access memory, or both. In some cases, the memory 3220 can be employed as active or physical memory by one or more executing software modules.

The storage device(s) 3230 can be configured to provide (e.g., persistent) mass storage for the system 3200. In some implementations, the storage device(s) 3230 can include one or more computer-readable media. For example, the storage device(s) 3230 can include a floppy disk device, a hard disk device, an optical disk device, or a tape device. The storage device(s) 3230 can include read-only memory, random access memory, or both. The storage device(s) 3230 can include one or more of an internal hard drive, an external hard drive, or a removable drive. The storage device(s) 3230 can implement the database 150.

One or both of the memory 3220 or the storage device(s) 3230 can include one or more computer-readable storage media (CRSM). The CRSM can include one or more of an electronic storage medium, a magnetic storage medium, an optical storage medium, a magneto-optical storage medium, a quantum storage medium, a mechanical computer storage medium, and so forth. The CRSM can provide storage of computer-readable instructions describing data structures, processes, applications, programs, other modules, or other data for the operation of the system 3200. In some implementations, the CRSM can include a data store that provides storage of computer-readable instructions or other information in a non-transitory format. The CRSM can be incorporated into the system 3200 or can be external with respect to the system 3200. The CRSM can include read-only memory, random access memory, or both. One or more CRSM suitable for tangibly embodying computer program instructions and data can include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some cases, the processor(s) 3210 and the memory 3220 can be supplemented by, or incorporated into, one or more application-specific integrated circuits (ASICs).

The system 3200 can include one or more I/O devices 3250. The I/O device(s) 3250 can include one or more input devices such as a keyboard, a mouse, a pen, a game controller, a touch input device, an audio input device (e.g., a microphone), a gestural input device, a haptic input device, an image or video capture device (e.g., a camera), or other devices. In some cases, the I/O device(s) 3250 can also include one or more output devices such as a display, LED(s), an audio output device (e.g., a speaker), a printer, a haptic output device, and so forth. The I/O device(s) 3250 can be physically incorporated in one or more computing devices of the system 3200, or can be external with respect to one or more computing devices of the system 3200.

The system 3200 can include one or more I/O interfaces 3240 to enable components or modules of the system 3200 to control, interface with, or otherwise communicate with the I/O device(s) 3250. The I/O interface(s) 3240 can enable information to be transferred in or out of the system 3200, or between components of the system 3200, through serial communication, parallel communication, or other types of communication. For example, the I/O interface(s) 3240 can comply with a version of the RS-232 standard for serial ports, or with a version of the IEEE 1284 standard for parallel ports. As another example, the I/O interface(s) 3240 can be configured to provide a connection over Universal Serial Bus (USB) or Ethernet. In some cases, the I/O interface(s) 3240 can be configured to provide a serial connection that is compliant with a version of the IEEE 1394 standard.

The I/O interface(s) 3240 can also include one or more network interfaces that enable communications between computing devices in the system 3200, or between the system 3200 and other network-connected computing systems. The network interface(s) can include one or more network interface controllers (NICs) or other types of transceiver devices configured to send and receive communications over one or more networks, such as the network(s) 130, using any network protocol.

Computing devices of the system 3200 can communicate with one another, or with other computing devices, using one or more networks such as the network(s) 130. Such networks can include public networks such as the internet, private networks such as an institutional or personal intranet, or any combination of private and public networks. The networks can include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices can be encrypted or otherwise secured. For example, communications can employ one or more public or private cryptographic keys, ciphers, digital certificates, or other credentials supported by a security protocol, such as any version of the Secure Sockets Layer (SSL) or the Transport Layer Security (TLS) protocol.

The system 3200 can include any number of computing devices of any type. The computing device(s) can include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. While examples herein can describe the execution of one or more processes as being performed by a mobile application (such as application 2100), a web-based interface or application can alternatively or additionally be used to execute the processes described herein. In addition, although examples herein can describe computing device(s) as physical device(s), implementations are not so limited. In some cases, a computing device can include one or more of a virtual computing environment, a hypervisor, an emulation, or a virtual machine executing on one or more physical computing devices. In some cases, two or more computing devices can include a cluster, cloud, farm, or other grouping of multiple devices that coordinate operations to provide load balancing, failover support, parallel processing capabilities, shared storage resources, shared networking capabilities, or other aspects.

The features described can be implemented in digital electronic circuitry or in computer hardware, software, or any combinations of hardware and software. The features can be implemented in at least one computer program product that is tangibly embodied in an information carrier (e.g., a machine-readable storage device) for execution by a programmable processor. The method or process steps can be performed by a programmable processor executing instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program can include a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module suitable for use in a computing environment.

The logic flows depicted in the figures do not require the particular order shown, or any particular sequential order, to achieve desirable results. In some implementations, other steps can be provided or steps can be eliminated from the described flows. Moreover, the steps can be performed in parallel or serially with respect to other steps. The systems depicted in the figures do not require the particular components, or the particular arrangement of components, shown in the figures. In some implementations, the various systems can include more or fewer components than shown in the figures, and components can be arranged differently to achieve desirable results. Accordingly, implementations other than those explicitly depicted in the figures or described herein are within the scope of the following claims.

Although the example UIs herein can include various elements in an example arrangement, implementations are not limited to these examples. Any of the UIs described herein, or the various screens thereof, can include any number of elements of any type, in any arrangement. UI elements can include any number of controls such as buttons, radio buttons, sliders, menus, lists, and so forth. UI elements can include any number of dialogs to enable entry of any type of information. A UI can be presented in a single screen, page, or window, or in multiple screens, pages, or windows. A UI can present information visually. A UI can also present information as audio output, haptic output (e.g., via movements of a device), or through other methods.

A number of implementations of the present disclosure have been described. Nevertheless, it will be understood that various modifications can be made without departing from the spirit and scope of the present disclosure. Accordingly, other implementations are within the scope of the following claims.

What is claimed is:

1. A computer-implemented method comprising:
receiving, from a plurality of computing systems each associated with a respective school of a plurality of schools, information for a plurality of persons, each person of the plurality of persons being associated with one or more schools of the plurality of schools;
sending, to an electronic device, an invitation for a first person of the plurality of persons to obtain a first digital credential that is configured to enable the first person to access one or more facilities of each of the plurality of schools;
receiving, from the electronic device, identification information for the first person;
authenticating the first person using the identification information for the first person; and
in response to authenticating the first person, providing, to the electronic device, the first digital credential.

2. The computer-implemented method of claim 1, wherein each person of the plurality of persons is assigned to at least one role of a plurality of roles, the plurality of roles including at least a guardian role and a student role, wherein each person assigned to the guardian role is associated with at least one person assigned to the student role.

3. The computer-implemented method of claim 1, wherein each person of the plurality of persons is assigned to at least one role of a plurality of roles, the plurality of roles including one or more of: a visitor role, a faculty role, a staff role, a volunteer role, a guardian role, and a student role.

4. The computer-implemented method of claim 1, wherein sending, to the electronic device, the invitation to obtain the first digital credential comprises:
identifying, from the information received from the plurality of computing systems, an electronic contact address for the first person; and
sending the invitation to the electronic contact address for the first person.

5. The computer-implemented method of claim 1, comprising:
storing the information for the plurality of persons in a database; and
generating the first digital credential in response to determining that the received identification information for the first person satisfies criteria for matching information for the first person stored in the database.

6. The computer-implemented method of claim 1, wherein the identification information for the first person comprises data representing an identification document for the first person, the computer-implemented method comprising:
storing, in a database, the data representing the identification document for the first person; and
performing a screening for the first person using the data representing the identification document.

7. The computer-implemented method of claim 1, wherein the identification information for the first person comprises:
data representing an identification document for the first person; and
one or more images generated by a camera of the electronic device,
wherein authenticating the first person using the identification information comprises:
determining that the data representing the identification document for the first person satisfies criteria for matching the one or more images generated by the camera of the electronic device.

8. The computer-implemented method of claim 1, wherein:
the identification information for the first person comprises one or more images generated by a camera of the electronic device, and
authenticating the first person using the identification information comprises performing liveness detection on the one or more images generated by the camera of the electronic device.

9. The computer-implemented method of claim 1, wherein each person of the plurality of persons is assigned to one or more of a plurality of roles, the plurality of roles including at least a guardian role and a student role, wherein each person assigned to the guardian role is associated with at least one person assigned to the student role, the computer-implemented method comprising:
determining that the first person is assigned to the guardian role;
determining at least one student associated with the first person, wherein a student comprises a person who is assigned to the student role; and
in response, providing, to the electronic device, access to a student management application, wherein the access to the student management application enables the first person to request changes to stored information for the at least one student.

10. The computer-implemented method of claim 9, wherein:
the at least one person assigned to the student role comprises a first student and a second student; and
the first student and the second student attend the same school of the plurality of schools or attend different schools of the plurality of schools.

11. The computer-implemented method of claim 9, comprising:
providing, through the student management application, a user interface that enables the first person to request a change in information for a first student of the at least one person assigned to the student role;
receiving, through the student management application, a request for a first change of information for the first student; and
in response, performing the first change of information for the first student in a database.

12. The computer-implemented method of claim 11, wherein the first change of information for the first student comprises a change to an after-school dismissal action for the first student,
wherein the change to the after-school dismissal action comprises assigning the first student to a carpool assigned to a second person of the plurality of persons, the computer-implemented method comprising:
identifying, from the database, an electronic contact address for the second person; and
sending, to electronic contact address for the second person, a notification that the first student is assigned to the carpool.

13. The computer-implemented method of claim 1, wherein:
each person of the plurality of persons is assigned to at least one role of a plurality of roles;
a digital credential for a person of the plurality of persons indicates the assigned at least one role assigned to the person;
each role of the plurality of roles is associated with corresponding access criteria and is permitted to access the one or more facilities of the plurality of schools when the corresponding access criteria is satisfied; and
the method further comprises:
detecting, at an access point to a facility of a school of the plurality of schools, a digital credential;
identifying one or more assigned roles indicated by the digital credential; and
determining, based on the one or more assigned roles, whether the corresponding access criteria is satisfied for entry through the access point to the facility.

14. The computer-implemented method of claim 13, comprising:
in response to determining that the corresponding access criteria is satisfied, allowing the person to proceed through the access point; or
in response to determining that the corresponding access criteria is not satisfied, preventing the person from proceeding through the access point.

15. The computer-implemented method of claim 13, wherein the access criteria comprises at least one of:
permissions to enter through a designated access point of multiple access points of the school; or
permissions to enter the school within a designated time range.

16. The computer-implemented method of claim 1, wherein:
two or more of the plurality of schools are associated with a single school system having a common administration; or
two or more the plurality of schools are associated with multiple different school systems having different respective administrations.

17. The computer-implemented method of claim 1, wherein providing, to the electronic device, the first digital credential comprises storing, on the electronic device, a scannable code for authenticating the first person that is configured to be presented on the electronic device for processing by a second electronic device for verification of the first person's identity.

18. The computer-implemented method of claim 1, further comprising:
receiving, from the electronic device, registration information, the registration information including a request to register the first person for an event; and
in response to receiving the registration information, providing, to the electronic device, a second digital credential, the second digital credential being specific to the event.

19. One or more non-transitory computer readable storage media storing instructions that, when executed by at least one processor, cause the at least one processor to perform operations comprising:
receiving, from a plurality of computing systems each associated with a respective school of a plurality of schools, information for a plurality of persons, each person of the plurality of persons being associated with one or more schools of the plurality of schools;
sending, to an electronic device, an invitation for a first person of the plurality of persons to obtain a first digital credential that is configured to enable the first person to access one or more facilities of each of the plurality of schools;
receiving, from the electronic device, identification information for the first person;
authenticating the first person using the identification information for the first person; and
in response to authenticating the first person, providing, to the electronic device, the first digital credential.

20. A system comprising:
one or more processors; and
one or more tangible, non-transitory media operably connectable to the one or more processors and storing instructions that, when executed, cause the one or more processors to perform operations comprising:
receiving, from a plurality of computing systems each associated with a respective school of a plurality of schools, information for a plurality of persons, each person of the plurality of persons being associated with one or more schools of the plurality of schools;
sending, to an electronic device, an invitation for a first person of the plurality of persons to obtain a first digital credential that is configured to enable the first person to access one or more facilities of each of the plurality of schools;
receiving, from the electronic device, identification information for the first person;
authenticating the first person using the identification information for the first person; and
in response to authenticating the first person, providing, to the electronic device, the first digital credential.
